(19) United States
(12) Patent Application Publication
(10) Pub. No.: US 2026/0104859 A1
(43) Pub. Date: Apr. 16, 2026

(54) PROCESSING UNIT, PROCESSING-IN-MEMORY DEVICE, AND PROCESSING-IN-MEMORY SYSTEM BASED ON REDUNDANT RESIDUE NUMBER SYSTEM

(71) Applicant: SK hynix Inc., Icheon-si Gyeonggi-do (KR)

(72) Inventor: Seong Ju LEE, San Jose, CA (US)

(73) Assignee: SK hynix Inc., Icheon-si Gyeonggi-do (KR)

(21) Appl. No.: 19/332,452

(22) Filed: Sep. 18, 2025

Related U.S. Application Data
(60) Provisional application No. 63/706,595, filed on Oct. 11, 2024.

(30) Foreign Application Priority Data
Aug. 26, 2025 (KR) 10-2025-0119110

(51) Int. Cl. G06F 7/72; G06F 15/78

(52) U.S. Cl. CPC G06F 7/729; G06F 15/7821

(57) ABSTRACT

A processing unit includes a redundant residue number generation circuit configured to convert first operand data and second operand data into a plurality of first operand redundant residue number sets, and a plurality of second operand redundant residue number sets based on a redundant residue number system (RRNS) using first to T-th moduli. T is a natural number equal to or greater than four. The processing unit includes a plurality of arithmetic circuits configured to perform operations using the plurality of first operand redundant residue number sets and the plurality of second operand redundant residue number sets, and a reconstruction circuit configured to recover result data based on the RRNS into result data based on a weighted number system.

### CROSS-REFERENCE TO RELATED APPLICATION

The present application claims benefit under 35 U.S.C § 119(e) to U.S. Provisional application number 63/706,595 filed on Oct. 11, 2024, and claims priority under 35 U.S.C. § 119(a) to Korean Patent application number 10-2025-0119110 filed on Aug. 26, 2025, in the Korean Intellectual Property Office, which applications are incorporated herein by reference in their entirety.

### BACKGROUND

### 1. Technical Field

Various embodiments of the present disclosure generally relate to processing unit, processing-in-memory (PIM) device, and PIM system, and more particularly, to processing unit, PIM device, and PIM system based on redundant residue number system (RRNS).

### 2. Related Art

In recent years, interest in artificial intelligence (AI) has rapidly increased not only in the information technology (IT) industry but also across various fields such as finance and healthcare. Accordingly, the introduction of artificial intelligence, more specifically deep learning, is being considered and prototyped in diverse industries. Generally, deep learning refers to a technology that effectively trains deep neural networks (DNNs), that are neural networks with an increased number of layers, and applies the trained networks to pattern recognition or inference.

One of the factors behind this widespread interest in deep learning is the improvement in the performance of processors that perform computations. In order to enhance the performance of artificial intelligence, neural networks are trained with as many as hundreds of layers. This trend has continued in recent years, and as a result, the computational demand required of hardware performing the actual operations has exponentially increased. Moreover, in conventional hardware systems where memory and processors are separated, the data communication bandwidth between the memory and the processor has become a bottleneck, hindering improvements in artificial intelligence hardware performance.

To address this issue, processing-in-memory (PIM) devices, in which the processor and the memory are integrated within the semiconductor chip itself, have recently been employed as computing devices for neural network operations. A PIM device includes a large number of arithmetic circuits that perform neural network computations including matrix multiplication. However, the arithmetic circuits included in the PIM device may be vulnerable to changes in voltage or temperature, and there also exists the possibility of defects caused by particles. Due to these and other factors, computational errors may occur in the arithmetic circuits, and such computational errors may result in erroneous outcomes in the training and inference of deep learning.

### SUMMARY

In an embodiment, a processing unit may include a redundant residue number generation circuit configured to convert first operand data and second operand data into a plurality of first operand redundant residue number sets and a plurality of second operand redundant residue number sets based on a redundant residue number system (RRNS) using first to T-th moduli, wherein T is a natural number equal to or greater than four, a plurality of arithmetic circuits configured to perform operations using the plurality of first operand redundant residue number sets and the plurality of second operand redundant residue number sets, and a reconstruction circuit configured to recover result data based on the RRNS into result data based on a weighted number system.

In an embodiment, a PIM device may include a memory circuit configured to provide first to M-th weight data and first to M-th vector data, wherein M is a natural number equal to or greater than two, and a processing unit configured to convert the first to M-th weight data and the first to M-th vector data into first to M-th weight redundant residue number sets and first to M-th vector redundant residue number sets based on a redundant residue number system (RRNS) using first to T-th moduli, wherein T is a natural number equal to or greater than four, and to perform multiplication and accumulation (MAC) operations. The processing unit is configured to perform a reconstruction operation to recover RRNS-based MAC result data generated as a result of the MAC operations into MAC result data based on a weighted number system, and to correct errors that occur in the RRNS-based MAC result data during the MAC operations.

In an embodiment, a PIM device may include a redundant residue number generation circuit configured to receive data in an 8-bit integer format from a host, perform modular operations on unsigned data excluding a sign bit using first to T-th moduli, wherein T is a natural number equal to or greater than four, to generate first to T-th redundant residues based on a redundant residue number system (RRNS), and to output the redundant residues together with the sign bit, a memory circuit configured to receive and store the sign bit and the first to T-th redundant residues output from the redundant residue number generation circuit, and a processing unit configured to receive the sign bit and the first to T-th redundant residues from the memory circuit as operands and to perform multiplication and accumulation (MAC) operations.

In an embodiment, a PIM system may include a host including a redundant residue number generation circuit configured to perform modular operations on unsigned write data, that excludes a sign bit of write data in an 8-bit signed integer format, using first to T-th moduli, wherein T is a natural number equal to or greater than four, to generate first to T-th redundant residues based on a redundant residue number system (RRNS), and to output the redundant residues together with the sign bit, and a PIM device including a memory circuit configured to receive and store the sign bit and the first to T-th redundant residues output from the host, and a processing unit configured to receive the sign bit and the first to T-th redundant residues from the memory circuit as operands and to perform multiplication and accumulation (MAC) operations.

### BRIEF DESCRIPTION OF THE DRAWINGS

FIG. 1 is a block diagram illustrating an example of a PIM device according to an embodiment of the present disclosure.

FIG. 2 is a diagram illustrating an example of a matrix-vector multiplication performed in the PIM device according to an embodiment of the present disclosure.

FIG. 3 is a diagram illustrating an RRNS transformation performed on elements of the weight matrix and input vector of FIG. 2 by a processing unit included in the PIM device according to an embodiment of the present disclosure.

FIG. 4 is a block diagram illustrating a processing unit included in the PIM device according to an embodiment of the present disclosure.

FIG. 5 is a block diagram illustrating an example of a redundant residue number (RRN) generation circuit included in the processing unit of FIG. 4.

FIG. 6 is a block diagram illustrating an example of a first modular arithmetic circuit of FIG. 5.

FIG. 7 is a block diagram illustrating an example of a multiplication circuit included in the processing unit of FIG. 4.

FIG. 8 is a diagram illustrating an example of a first multiplication circuit included in the multiplication circuit of FIG. 7.

FIG. 9 is a diagram illustrating an example of a first multiplier included in the first multiplication circuit of FIG. 8.

FIG. 10 is a diagram illustrating an example of a third multiplier included in the first multiplication circuit of FIG. 8.

FIG. 11 is a circuit diagram illustrating an AND array block of the third multiplier of FIG. 10 according to an embodiment of the present disclosure.

FIG. 12 is a diagram illustrating an example of a fifth multiplier included in the first multiplication circuit of FIG. 8.

FIG. 13 is a circuit diagram illustrating an AND array block of the fifth multiplier of FIG. 12 according to an embodiment of the present disclosure.

FIG. 14 is a block diagram illustrating an example of an addition circuit included in the processing unit of FIG. 4.

FIG. 15 is a block diagram illustrating an example of a first adder included in the addition circuit of FIG. 14.

FIG. 16 is a diagram illustrating an example of an accumulation circuit included in the processing unit of FIG. 4.

FIG. 17 is a block diagram illustrating an example of a reconstruction circuit included in the processing unit of FIG. 4.

FIG. 18 is a block diagram illustrating an example of a real number generation circuit included in the reconstruction circuit of FIG. 17.

FIG. 19 is a diagram illustrating an example of an operation process in a first real number calculator of FIG. 18.

FIG. 20 is a diagram illustrating another example of an operation process in the first real number calculator of FIG. 18.

FIG. 21 is a block diagram illustrating an example of an error-corrected real number generation circuit included in the reconstruction circuit of FIG. 17 according to an embodiment of the present disclosure.

FIG. 22 is a block diagram illustrating another example of a PIM device according to an embodiment of the present disclosure.

FIG. 23 is a diagram illustrating a data processing procedure based on RRNS performed in the PIM device of FIG. 22 according to an embodiment of the present disclosure.

FIG. 24 is a block diagram illustrating an example of a redundant residue number generation circuit included in the PIM device of FIG. 22 according to an embodiment of the present disclosure.

FIG. 25 is a block diagram illustrating a processing unit included in the PIM device of FIG. 22 according to an embodiment of the present disclosure.

FIG. 26 is a block diagram illustrating an example of a PIM system according to an embodiment of the present disclosure.

### DETAILED DESCRIPTION

Terms such as “first” and “second” are used to distinguish between various elements and do not imply size, order, priority, quantity, or importance of the elements. For example, a first element may be referred to as a second element in one example, and the second element may be referred to as a first element in another example.

When an element is referred to as “connected” or “coupled” to another element, the elements may be connected directly or through one or more intervening elements between the elements. When two elements are referred to as “directly connected” or “directly coupled,” one element is directly connected or directly coupled to the other element without an intervening element between the two elements.

Terms such as “over,” “on,” “inside,” “higher,” “high,” “low,” “left,” “right,” “column,” “row,” “level,” and other terms implying relative spatial relationship or orientation are utilized only for the purpose of ease of description or reference to a drawing and are not otherwise limiting.

Embodiments of the present disclosure are described in detail with reference to the accompanying drawings. Specific structural or functional descriptions of embodiments are provided as examples for illustrative purposes to describe concepts that are disclosed in the present application. Examples or embodiments in accordance with the concepts may be carried out in various forms, and the scope of the present disclosure is not limited to the examples or embodiments described in this specification.

It should be understood that the various embodiments described below take DRAM as an example as a memory device, but are not limited thereto. For example, the same may be applied to static random access memory (SRAM), synchronous DRAM (SDRAM), double data rate synchronous DRAM (DDR SDRAM, DDR2 SDRAM, DDR3 SDRAM, etc.), graphics double data rate synchronous DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data output DRAM (EDO DRAM), burst EDO DRAM (BEDO DRAM), multibank DRAM (MDRAM), synchronous graphics RAM (SGRAM), and/or other various forms of DRAM.

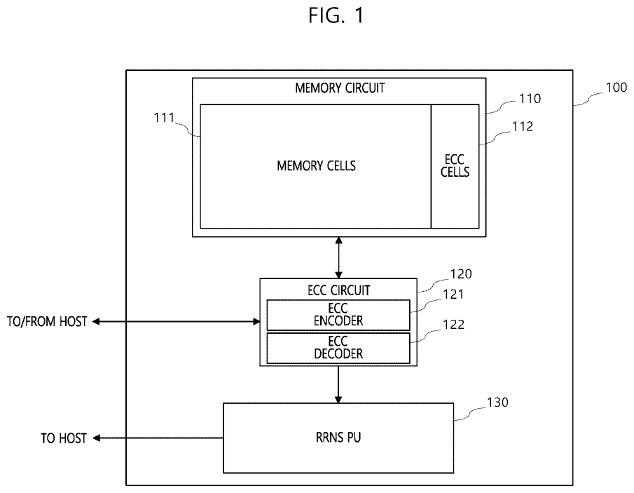

FIG. 1 is a block diagram illustrating an example of a PIM device according to an embodiment of the present disclosure.

Referring to FIG. 1, a PIM device 100 includes a memory circuit 110, an error correction code (ECC) circuit 120, and a processing unit 130. The memory circuit 110 may include memory cells 111 and ECC cells 112. The memory cells 111 and the ECC cells 112 may have a cell array structure. The memory circuit 110 may perform a memory read operation, a memory write operation, and an operation read operation.

Through the memory read operation, the memory circuit 110 may transmit data stored in the memory circuit 110 to a host as read data. Through the memory write operation, the memory circuit 110 may store data transmitted from the host as write data. In one example, the host may include a controller. Through the operation read operation, the memory circuit 110 may provide operand data, that is part of the write data stored in the memory circuit 110, to the processing unit 130.

The memory cells 111 of the memory circuit 110 store the write data. The write data may include operand data provided to the processing unit 130. The operand data may include weight data and vector data used in a multilayer perceptron (MLP) operation. The ECC cells 112 of the memory circuit 110 store parity data corresponding to the write data. The parity data may be used to detect and correct errors in the data stored in the memory cells 111.

The ECC circuit 120 may include an ECC encoder 121 used in the memory write operation and an ECC decoder 122 used in the memory read operation and the operation read operation. Specifically, the ECC encoder 121 performs ECC encoding on the write data transmitted from the host to generate parity data corresponding to the write data. The ECC encoder 121 transmits the write data and the parity data respectively to the memory cells 111 and the ECC cells 112 of the memory circuit 110. The ECC decoder 122 performs ECC decoding on the read data transmitted from the memory circuit 110 to detect and correct errors of the read data. The error detection and correction according to the ECC decoding may be performed using the parity data transmitted together with the read data from the memory circuit 110. The ECC decoder 122 may transmit error-corrected data either to the host or to the processing unit 130.

The processing unit 130 may perform multiplication and accumulation (MAC) operations on the weight data and vector data transmitted from the memory circuit 110 through the ECC circuit 120, and may generate MAC result data. The processing unit 130 may generate first through T-th weight redundant residue numbers by using first through T-th moduli, where T is a natural number greater than or equal to four. The processing unit 130 may also generate first through T-th vector redundant residue numbers for the vector data by using the first through T-th moduli. Among the first through T-th moduli, the first through third moduli may serve as a basic modulus set of a residue number system (RNS) and may be referred to as information moduli. The remaining moduli, excluding the first through third moduli, may be referred to as redundant moduli.

In the following description, an example is provided in which T is equal to five, that is, the first through fifth moduli are used. The description below may also be applied in the same manner when the number of moduli is other than five. The processing unit 130 may generate first through fifth weight redundant residue numbers for weight data by using the first through fifth moduli. The processing unit (PU) 130 may also generate first through fifth vector redundant residue numbers for vector data by using the first through fifth moduli. The processing unit 130 may perform MAC operations by using the first through fifth weight redundant residue numbers and the first through fifth vector redundant residue numbers. As a result of the MAC operations, the processing unit 130 may generate first through fifth accumulated redundant residue numbers. The processing unit 130 may convert the first through fifth accumulated redundant residue numbers, that are based on a redundant residue number system (RRNS), into MAC result data based on a weighted number system, and may output the MAC result data to the host. The processing unit 130 may also be configured to correct errors occurring during the MAC operations by using the first through fifth moduli and the first through fifth accumulated redundant residue numbers.

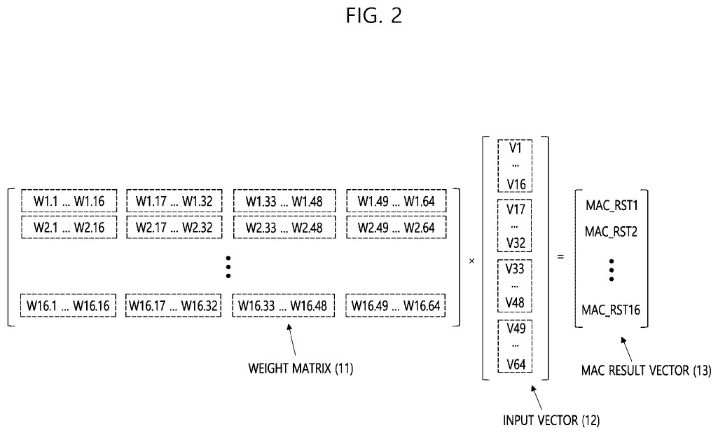

FIG. 2 is a diagram illustrating an example of a matrix-vector multiplication performed in the PIM device according to an embodiment of the present disclosure.

Referring to FIG. 2, a PIM device performs a matrix-vector multiplication on a weight matrix 11 and an input vector 12, and generates a MAC result vector 13 as a result. In this example, it is assumed that the weight matrix 11 has a 16×64 matrix format, where the elements are weight data W1.1-W1.64, W2.1-W2.64, . . . , W16.1-W16.64 corresponding to the first through sixteenth rows and the first through sixty-fourth columns. It is further assumed that the input vector 12 has a 64×1 vector format, where the elements are vector data V1-V64 corresponding to the first through sixty-fourth rows. In this case, the MAC result vector 13 has a 16×1 vector format, where the elements are MAC result data MAC_RST1-MAC_RST16 corresponding to the first through sixteenth rows.

As an example, first through fourth MAC operations for the weight data W1.1-W1.64 of the first row of the weight matrix 11 will be described. The following description may also be applied in the same manner to the first through fourth MAC operations for the weight data of each of the second through sixteenth rows of the weight matrix 11.

The first MAC operation for the first row of the weight matrix 11 is performed as a first matrix-vector multiplication with respect to the weight data W1.1-W1.16 of the first row and the first through sixteenth columns, and the vector data V1-V16 of the first through sixteenth rows. As a result of the first MAC operation, first accumulated data, that is the result of the first matrix-vector multiplication, is generated.

The second MAC operation for the first row of the weight matrix 11 is performed as a second matrix-vector multiplication and a first accumulation operation. The second matrix-vector multiplication is performed with respect to the weight data W1.17-W1.32 of the first row and the seventeenth through thirty-second columns, and the vector data V17-V32 of the seventeenth through thirty-second rows. The first accumulation operation is performed by adding the result of the second matrix-vector multiplication to the first accumulated data. As a result of the second MAC operation, second accumulated data is generated.

The third MAC operation for the first row of the weight matrix 11 is performed as a third matrix-vector multiplication and a second accumulation operation. The third matrix-vector multiplication is performed with respect to the weight data W1.33-W1.48 of the first row and the thirty-third through forty-eighth columns, and the vector data V33-V48 of the thirty-third through forty-eighth rows. The second accumulation operation is performed by adding the result of the third matrix-vector multiplication to the second accumulated data. As a result of the third MAC operation, third accumulated data is generated.

Finally, the fourth MAC operation for the first row of the weight matrix 11 is performed as a fourth matrix-vector multiplication and a third accumulation operation. The fourth matrix-vector multiplication is performed with respect to the weight data W1.49-W1.64 of the first row and the forty-ninth through sixty-fourth columns, and the vector data V49-V64 of the forty-ninth through sixty-fourth rows. The third accumulation operation is performed by adding the result of the fourth matrix-vector multiplication to the third accumulated data. As a result of the fourth MAC operation, the first MAC result data MAC_RST1 of the MAC result vector 130 is generated.

The sizes of the weight matrix 11 and the input vector 12 in this example are merely illustrative, and the sizes of the weight matrix 11 and the input vector 12 may be variously set as long as the number of columns of the weight matrix 11 matches the number of rows of the input vector 12. In one example, the weight data W1.1-W1.64, W2.1-W2.64, . . . , W16.1-W16.64 and the vector data V1-V64 may be data used for multilayer perceptron (MLP) operations. In the following examples, it is assumed that the weight data W1.1-W1.64, W2.1-W2.64, . . . , W16.1-W16.64 and the vector data V1-V64 are signed 8-bit integers in a fixed-point format.

The matrix-vector multiplication of the weight matrix 11 and the input vector 12 in the PIM device may be performed by repeating multiple MAC operations for each of the first through sixteenth rows of the weight matrix 11. The number of MAC operations for one row of the weight matrix 11 may be determined according to the computational capability of the PIM device. In the following examples, it is assumed that the PIM device is designed to use sixteen weight data and sixteen vector data in a single MAC operation. In this case, the MAC operator outputs MAC result data (MAC_RST) for one row of the weight matrix 11 through the first through fourth MAC operations.

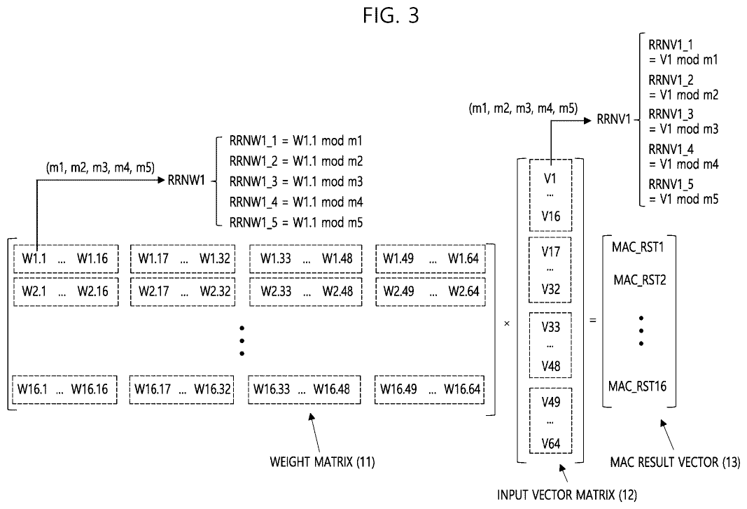

FIG. 3 is a diagram illustrating an RRNS transformation performed on elements of the weight matrix and input vector of FIG. 2 by a processing unit included in the PIM device according to an embodiment of the present disclosure.

Referring to FIG. 3, a processing unit of a PIM device performs an RRNS transformation on the weight data W1.1-W1.64, W2.1-W2.64, . . . , W16.1-W16.64 of the weight matrix 11 and the vector data V1-V64 of the input vector 12. Through the RRNS transformation, the processing unit generates sets of weight redundant residue numbers for the weight data W1.1-W1.64, W2.1-W2.64, . . . , W16.1-W16.64. Each of the sets of weight redundant residue numbers may include first through fifth weight redundant residue numbers. The processing unit also generates sets of vector redundant residue numbers for the vector data V1-V64 through the RRNS transformation. Each of the sets of vector redundant residue numbers may include first through fifth vector redundant residue numbers.

In the following description, an example is provided in that the RRNS transformation is performed on the weight data W1.1 of the first row and first column of the weight matrix 11, and the vector data V1 of the first row of the input vector 12. The RRNS transformation process for the weight data W1.1 and the vector data V1 may also be applied in the same manner to the remaining weight data of the weight matrix 11 and the remaining vector data of the input vector 12.

First through fifth modular operations are performed on the weight data W1.1 by using first through fifth moduli m1-m5. Among the first through fifth moduli m1-m5, the first through third moduli m1-m3 may serve as a basic modulus set of a residue number system (RNS) and may be referred to as information moduli. The fourth and fifth moduli m4 and m5 may be referred to as redundant moduli. The first through fifth moduli m1-m5 may be set as positive integers satisfying the following two conditions. A first condition is that the first through fifth moduli m1-m5 are pairwise relatively prime. A second condition is that the product of the first through third moduli m1-m3 is greater than a maximum value that the weight data W1.1 may assume.

The first modular operation for the weight data W1.1 is performed as an operation of (W1.1 mod m1). As a result of the first modular operation, a first weight redundant residue number RRNW1_1 of a first weight redundant residue number set RRNW1 is generated. The first weight redundant residue number RRNW1_1 is a remainder obtained by dividing the weight data W1.1 by the first modulus m1.

The second modular operation for the weight data W1.1 is performed as an operation of (W1.1 mod m2). As a result of the second modular operation, a second weight redundant residue number RRNW1_2 of the first weight redundant residue number set RRNW1 is generated. The second weight redundant residue number RRNW1_2 is a remainder obtained by dividing the weight data W1.1 by the second modulus m2.

The third modular operation for the weight data W1.1 is performed as an operation of (W1.1 mod m3). As a result of the third modular operation, a third weight redundant residue number RRNW1_3 of the first weight redundant residue number set RRNW1 is generated. The third weight redundant residue number RRNW1_3 is a remainder obtained by dividing the weight data W1.1 by the third modulus m3.

The fourth modular operation for the weight data W1.1 is performed as an operation of (W1.1 mod m4). As a result of the fourth modular operation, a fourth weight redundant residue number RRNW1_4 of the first weight redundant residue number set RRNW1 is generated. The fourth weight redundant residue number RRNW1_4 is a remainder obtained by dividing the weight data W1.1 by the fourth modulus m4.

The fifth modular operation for the weight data W1.1 is performed as an operation of (W1.1 mod m5). As a result of the fifth modular operation, a fifth weight redundant residue number RRNW1_5 of the first weight redundant residue number set RRNW1 is generated. The fifth weight redundant residue number RRNW1_5 is a remainder obtained by dividing the weight data W1.1 by the fifth modulus m5. Accordingly, through the first through fifth modular operations for the weight data W1.1, the weight data W1.1 is transformed into the first weight redundant residue number set RRNW1 including the first through fifth weight redundant residue numbers RRNW1_1-RRNW1_5.

A first modular operation for the vector data V1 is performed as an operation of (V1 mod m1). As a result of the first modular operation, a first vector redundant residue number RRNV1_1 of a first vector redundant residue number set RRNV1 is generated. The first vector redundant residue number RRNV1_1 is a remainder obtained by dividing the vector data V1 by the first modulus m1.

A second modular operation for the vector data V1 is performed as an operation of (V1 mod m2). As a result of the second modular operation, a second vector redundant residue number RRNV1_2 of the first vector redundant residue number set RRNV1 is generated. The second vector redundant residue number RRNV1_2 is a remainder obtained by dividing the vector data V1 by the second modulus m2.

A third modular operation for the vector data V1 is performed as an operation of (V1 mod m3). As a result of the third modular operation, a third vector redundant residue number RRNV1_3 of the first vector redundant residue number set RRNV1 is generated. The third vector redundant residue number RRNV1_3 is a remainder obtained by dividing the vector data V1 by the third modulus m3.

A fourth modular operation for the vector data V1 is performed as an operation of (V1 mod m4). As a result of the fourth modular operation, a fourth vector redundant residue number RRNV1_4 of the first vector redundant residue number set RRNV1 is generated. The fourth vector redundant residue number RRNV1_4 is a remainder obtained by dividing the vector data V1 by the fourth modulus m4.

A fifth modular operation for the vector data V1 is performed as an operation of (V1 mod m5). As a result of the fifth modular operation, a fifth vector redundant residue number RRNV1_5 of the first vector redundant residue number set RRNV1 is generated. The fifth vector redundant residue number RRNV1_5 is a remainder obtained by dividing the vector data V1 by the fifth modulus m5. Accordingly, through the first through fifth modular operations for the vector data V1, the vector data V1 is transformed into the first vector redundant residue number set RRNV1 including the first through fifth vector redundant residue numbers RRNV1_1-RRNV1_5.

When the weight data W1.1 and the vector data V1 are binary values in a signed 8-bit integer (INT8) format, the first through fifth modular operations for the weight data W1.1 are performed on seven-bit unsigned weight data W1.1<6:0>, excluding the sign bit W1.1<7>. Similarly, the first through fifth modular operations for the vector data V1 are performed on seven-bit unsigned vector data V1<6:0>, excluding the sign bit V1<7>.

Weight redundant residue numbers and vector redundant residue numbers generated through modular operations using the same modulus may have the same bit length. For example, the first weight redundant residue number RRNW1_1 and the first vector redundant residue number RRNV1_1 generated by the first modular operation using the first modulus m1 have the same bit length. The second weight redundant residue number RRNW1_2 and the second vector redundant residue number RRNV1_2 generated by the second modular operation using the second modulus m2 also have the same bit length. The third weight redundant residue number RRNW1_3 and the third vector redundant residue number RRNV1_3 generated by the third modular operation using the third modulus m3 likewise have the same bit length. The fourth weight redundant residue number RRNW1_4 and the fourth vector redundant residue number RRNV1_4 generated by the fourth modular operation using the fourth modulus m4 also have the same bit length. In addition, the fifth weight redundant residue number RRNW1_5 and the fifth vector redundant residue number RRNV1_5 generated by the fifth modular operation using the fifth modulus m5 have the same bit length.

The bit lengths of the first through fifth weight redundant residue numbers RRNW1_1-RRNW1_5 and the first through fifth vector redundant residue numbers RRNV1_1-RRNV1_5 may be determined according to values of the moduli m used in the modular operations. Specifically, the bit length b of the first through fifth weight redundant residue numbers RRNW1_1-RRNW1_5 and the first through fifth vector redundant residue numbers RRNV1_1-RRNV1_5 may be determined by the equation (b=[log₂ m]). Here, log₂ m represents the number of bits required to represent all numbers smaller than the modulus m, and [ ] denotes a ceiling function that rounds up any fractional value.

In one example, when the first through fifth moduli m1-m5 are set to 3 (binary 11), 4 (binary 100), 5 (binary 101), 7 (binary 111), and 11 (binary 1011), respectively, the first weight redundant residue number RRNW1_1, the second weight redundant residue number RRNW1_2, the first vector redundant residue number RRNV1_1, and the second vector redundant residue number RRNV1_2 each have a bit length of two. The third weight redundant residue number RRNW1_3, the fourth weight redundant residue number RRNW1_4, the third vector redundant residue number RRNV1_3, and the fourth vector redundant residue number RRNV1_4 each have a bit length of three. In addition, the fifth weight redundant residue number RRNW1_5 and the fifth vector redundant residue number RRNV1_5 each have a bit length of four.

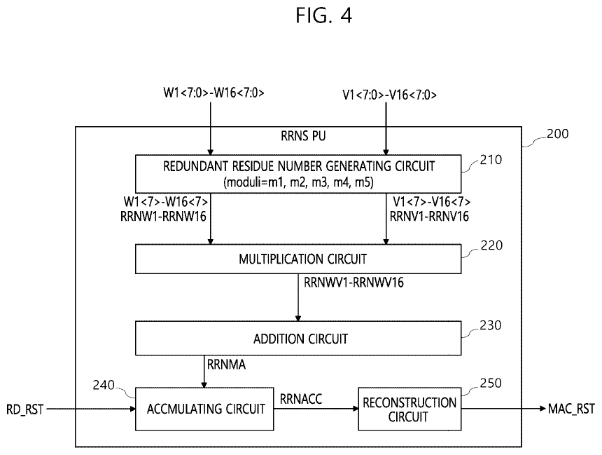

FIG. 4 is a block diagram illustrating a processing unit included in the PIM device according to an embodiment of the present disclosure. In this example, it is assumed that the processing unit has a computational capability of processing sixteen weight data and sixteen vector data in a single operation.

Referring to FIG. 4, a processing unit 200 receives first through sixteenth weight data W1-W16 and first through sixteenth vector data V1-V16. The processing unit 200 may also receive a MAC result read signal RD_RST as a control signal. The processing unit 200 performs MAC operations on the first through sixteenth weight data W1-W16 and the first through sixteenth vector data V1-V16. The first through sixteenth weight data W1-W16 may be a set of weight data of the weight matrix 11 of FIG. 2, for example, weight data W1.1-W1.16 corresponding to the first row and the first through sixteenth columns. When the MAC operations for one row of the weight matrix 11 are completed, the processing unit 200 may output MAC result data MAC_RST according to a logic level of the MAC result read signal RD_RST.

The processing unit 200 may include a redundant residue number generation circuit 210 that performs modular operations, a multiplication circuit 220 that performs multiplication operations, an addition circuit 230 that performs addition operations, an accumulation circuit 240 that performs accumulation operations, and a reconstruction circuit 250 that restores operation result data of the RRNS system into operation result data of a weighted number system.

The redundant residue number generation circuit 210 performs modular operations on first through sixteenth unsigned weight data W1<6:0>-W16<6:0>, excluding sign bits W1<7>-W16<7>, based on the RRNS, and generates and outputs first through sixteenth weight redundant residue number sets RRNW1-RRNW16. The redundant residue number generation circuit 210 also performs modular operations on first through sixteenth unsigned vector data V1<6:0>-V16<6:0>, excluding sign bits V1<7>-V16<7>, and generates and outputs first through sixteenth vector redundant residue number sets RRNV1-RRNV16. The redundant residue number generation circuit 210 outputs the first through sixteenth sign bits W1<7>-W16<7>of the first through sixteenth weight data W1-W16 and the first through sixteenth sign bits V1<7>-V16<7> of the first through sixteenth vector data V1-V16.

Each of the first through sixteenth weight redundant residue number sets RRNW1-RRNW16 includes first through fifth weight redundant residue numbers, and each of the first through sixteenth vector redundant residue number sets RRNV1-RRNV16 includes first through fifth vector redundant residue numbers. For example, as described with reference to FIG. 3, the redundant residue number generation circuit 210 performs modular operations on the first through sixteenth unsigned weight data W1<6:0>-W16<6:0> and the first through sixteenth unsigned vector data V1<6:0>-V16<6:0> by using the first through fifth moduli m1-m5. Accordingly, each of the first through sixteenth weight redundant residue number sets RRNW1-RRNW16 includes the first through fifth weight redundant residue numbers, and each of the first through sixteenth vector redundant residue number sets RRNV1-RRNV16 includes the first through fifth vector redundant residue numbers.

The multiplication circuit 220 receives the first through sixteenth sign bits W1<7>-W16<7> of the first through sixteenth weight data W1<7:0>-W16<7:0> and the first through sixteenth sign bits V1<7>-V16<7> of the first through sixteenth vector data V1<7:0>-V16<7:0> output from the redundant residue number generation circuit 210. The multiplication circuit 220 also receives the first through sixteenth weight redundant residue number sets RRNW1-RRNW16 and the first through sixteenth vector redundant residue number sets RRNV1-RRNV16 output from the redundant residue number generation circuit 210.

The multiplication circuit 220 performs multiplication operations on the first through sixteenth weight redundant residue number sets RRNW1-RRNW16 and the first through sixteenth vector redundant residue number sets RRNV1-RRNV16, respectively, to generate and output first through sixteenth multiplication redundant residue number sets RRNWV1-RRNWV16. Specifically, the multiplication circuit 220 performs a multiplication operation on the first weight redundant residue number set RRNW1 and the first vector redundant residue number set RRNV1 to generate and output a first multiplication redundant residue number set RRNWV1. The multiplication circuit 220 performs a multiplication operation on the second weight redundant residue number set RRNW2 and the second vector redundant residue number set RRNV2 to generate and output a second multiplication redundant residue number set RRNWV2. The multiplication circuit 220 generates and outputs third through sixteenth multiplication redundant residue number sets RRNWV3-RRNWV16 in the same manner.

Although not illustrated in the drawing, the multiplication operations for the weight redundant residue number sets and the vector redundant residue number sets in the multiplication circuit 220 are performed through first through fifth sub-multiplication operations. As an example, the multiplication operation for the first weight redundant residue number set RRNW1 and the first vector redundant residue number set RRNV1 will be described. The following description may also be applied in the same manner to the remaining multiplication operations. The multiplication operation for the first weight redundant residue number set RRNW1 and the first vector redundant residue number set RRNV1 is performed through first through fifth sub-multiplication operations.

A first sub-multiplication operation is performed on the first weight redundant residue number RRNW1_1 of the first weight redundant residue number set RRNW1 and the first vector redundant residue number RRNV1_1 of the first vector redundant residue number set RRNV1. As a result of the first sub-multiplication operation, a first multiplication redundant residue number of the first multiplication redundant residue number set RRNWV1 is generated.

A second sub-multiplication operation is performed on the second weight redundant residue number RRNW1_2 of the first weight redundant residue number set RRNW1 and the second vector redundant residue number RRNV1_2 of the first vector redundant residue number set RRNV1. As a result of the second sub-multiplication operation, a second multiplication redundant residue number of the first multiplication redundant residue number set RRNWV1 is generated.

A third sub-multiplication operation is performed on the third weight redundant residue number RRNW1_3 of the first weight redundant residue number set RRNW1 and the third vector redundant residue number RRNV1_3 of the first vector redundant residue number set RRNV1. As a result of the third sub-multiplication operation, a third multiplication redundant residue number of the first multiplication redundant residue number set RRNWV1 is generated.

A fourth sub-multiplication operation is performed on the fourth weight redundant residue number RRNW1_4 of the first weight redundant residue number set RRNW1 and the fourth vector redundant residue number RRNV1_4 of the first vector redundant residue number set RRNV1. As a result of the fourth sub-multiplication operation, a fourth multiplication redundant residue number of the first multiplication redundant residue number set RRNWV1 is generated.

A fifth sub-multiplication operation is performed on the fifth weight redundant residue number RRNW1_5 of the first weight redundant residue number set RRNW1 and the fifth vector redundant residue number RRNV1_5 of the first vector redundant residue number set RRNV1. As a result of the fifth sub-multiplication operation, a fifth multiplication redundant residue number of the first multiplication redundant residue number set RRNWV1 is generated.

The addition circuit 230 receives first through sixteenth multiplication redundant residue number sets RRNWV1-RRNWV16 output from the multiplication circuit 220. The addition circuit 230 performs addition operations on the first through sixteenth multiplication redundant residue number sets RRNWV1-RRNWV16 to generate an addition redundant residue number set RRNMA. Although not illustrated in the drawing, the addition redundant residue number set RRNMA generated from the addition circuit 230 includes first through fifth addition redundant residue numbers.

The accumulation circuit 240 receives the addition redundant residue number set RRNMA output from the addition circuit 230. The accumulation circuit 240 performs accumulation operations on the addition redundant residue number set RRNMA and a latch redundant residue number set to generate an accumulated redundant residue number set RRNACC. Although not illustrated in the drawing, the accumulation circuit 240 performs first through fifth sub-accumulation operations, in which the first through fifth addition redundant residue numbers included in the addition redundant residue number set RRNMA and the first through fifth latch redundant residue numbers included in the latch redundant residue number set are accumulated, respectively. Accordingly, the accumulated redundant residue number set RRNACC generated from the accumulation circuit 240 includes first through fifth accumulated redundant residue numbers.

The reconstruction circuit 250 receives the accumulated redundant residue number set RRNACC output from the accumulation circuit 240. The reconstruction circuit 250 generates MAC operation result data expressed in a binary weighted number system by using the first through fifth moduli m1-m5 and the first through fifth accumulated redundant residue numbers included in the accumulated redundant residue number set RRNACC. The reconstruction circuit 250 is configured to correct errors generated during MAC operations in the process of generating the MAC operation result data.

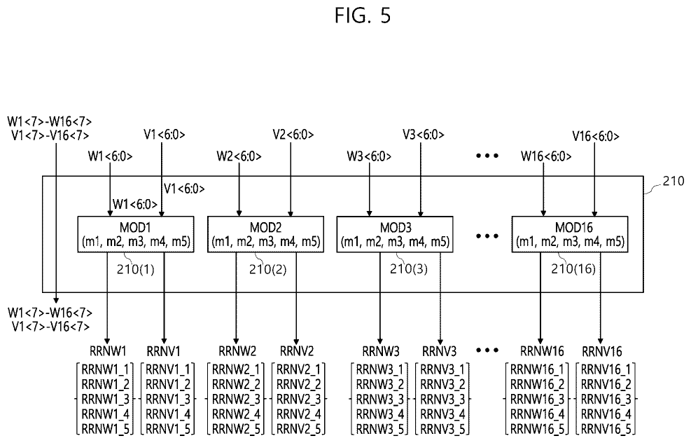

FIG. 5 is a block diagram illustrating an example of an RRN generation circuit included in the processing unit of FIG. 4.

Referring to FIG. 5, the redundant residue number generation circuit 210 receives first through sixteenth weight data W1<7:0>-W16<7:0>and first through sixteenth vector data V1<7:0>-V16<7:0>. The redundant residue number generation circuit 210 outputs sign bits W1<7>-W16<7> of the first through sixteenth weight data W1<7:0>-W16<7:0> and sign bits V1<7>-V16<7> of the first through sixteenth vector data V1<7:0>-V16<7:0> in the same form as received without modification. The redundant residue number generation circuit 210 performs first through sixteenth modular operations on unsigned weight data W1<6:0>-W16<6:0> and unsigned vector data V1<6:0>-V16<6:0>, excluding the sign bits, to output first through sixteenth weight redundant residue number sets RRNW1-RRNW16 and first through sixteenth vector redundant residue number sets RRNV1-RRNV16.

In one embodiment, the redundant residue number generation circuit 210 may include first through sixteenth modular arithmetic circuits MOD1-MOD16 (210(1)-210(16)). The first through sixteenth modular arithmetic circuits 210(1)-210(16) receive first through sixteenth unsigned weight data W1<6:0>-W16<6:0>and first through sixteenth unsigned vector data V1<6:0>-V16<6:0>. For example, the first modular arithmetic circuit 210(1) receives the first unsigned weight data W1<6:0> and the first unsigned vector data V1<6:0>. The second modular arithmetic circuit 210(2) receives the second unsigned weight data W2<6:0> and the second unsigned vector data V2<6:0>. The third modular arithmetic circuit 210(3) receives the third unsigned weight data W3<6:0> and the third unsigned vector data V3<6:0>. Likewise, the sixteenth modular arithmetic circuit 210(16) receives the sixteenth unsigned weight data W16<6:0> and the sixteenth unsigned vector data V16<6:0>.

Among the first through sixteenth modular arithmetic circuits 210(1)-210(16), a K-th modular arithmetic circuit 210(K), where K is a natural number from 1 to 16, performs K-th modular operations on a K-th unsigned weight data WK<6:0> and a K-th unsigned vector data VK<6:0> by using first through fifth moduli m1-m5. As a result of the K-th modular operations, the K-th modular arithmetic circuit 210(K) generates and outputs a K-th weight redundant residue number set RRNW“K” and a K-th vector redundant residue number set RRNV“K”. The K-th weight redundant residue number set RRNW“K” includes first through fifth weight redundant residue numbers, and the K-th vector redundant residue number set RRNV“K” includes first through fifth vector redundant residue numbers.

For example, the first modular arithmetic circuit 210(1) performs first modular operations on a first unsigned weight data W1<6:0> and a first unsigned vector data V1<6:0> by using first through fifth moduli m1-m5. As a result of the first modular operations, the first modular arithmetic circuit 210(1) outputs first through fifth weight redundant residue numbers RRNW1_1-RRNW1_5 of a first weight redundant residue number set RRNW1 and first through fifth vector redundant residue numbers RRNV1_1-RRNV1_5 of a first vector redundant residue number set RRNV1.

The second modular arithmetic circuit 210(2) performs second modular operations on a second unsigned weight data W2<6:0> and a second unsigned vector data V2<6:0> by using the first through fifth moduli m1-m5. As a result of the second modular operations, the second modular arithmetic circuit 210(2) outputs first through fifth weight redundant residue numbers RRNW2_1-RRNW2_5 of a second weight redundant residue number set RRNW2 and first through fifth vector redundant residue numbers RRNV2_1-RRNV2_5 of a second vector redundant residue number set RRNV2.

The third modular arithmetic circuit 210(3) performs third modular operations on a third unsigned weight data W3<6:0> and a third unsigned vector data V3<6:0> by using the first through fifth moduli m1-m5. As a result of the third modular operations, the third modular arithmetic circuit 210(3) outputs first through fifth weight redundant residue numbers RRNW3_1-RRNW3_5 of a third weight redundant residue number set RRNW3 and first through fifth vector redundant residue numbers RRNV3_1-RRNV3_5 of a third vector redundant residue number set RRNV3.

Similarly, the sixteenth modular arithmetic circuit 210(16) performs sixteenth modular operations on a sixteenth unsigned weight data W16<6:0> and a sixteenth unsigned vector data V16<6:0> by using the first through fifth moduli m1-m5. As a result of the sixteenth modular operations, the sixteenth modular arithmetic circuit 210(16) outputs first through fifth weight redundant residue numbers RRNW16_1-RRNW16_5 of a sixteenth weight redundant residue number set RRNW16 and first through fifth vector redundant residue numbers RRNV16_1-RRNV16_5 of a sixteenth vector redundant residue number set RRNV16.

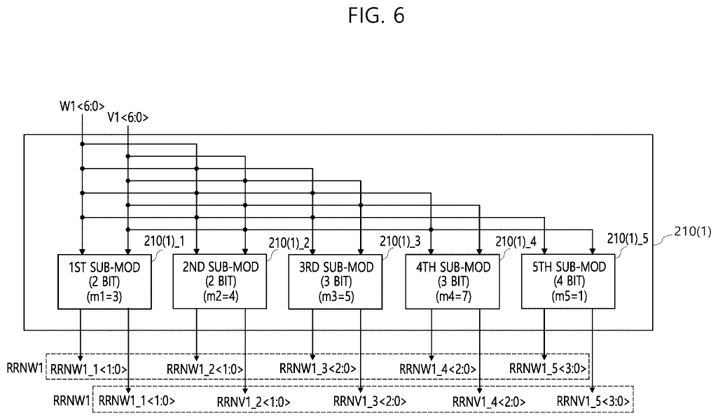

FIG. 6 is a block diagram illustrating an example of a first modular arithmetic circuit of FIG. 5. The following description may also be applied in the same manner to the second through sixteenth modular arithmetic circuits included in the redundant residue number generation circuit of FIG. 5. In this example, decimal values “3,” “4,” “5,” “7,” and “11” are assumed to be used as the first, second, third, fourth, and fifth moduli m1, m2, m3, m4, and m5, respectively. However, this is merely one embodiment, and the first through fifth moduli m1-m5 are not limited thereto and may be variously set.

Referring to FIG. 6, the first modular arithmetic circuit 210(1) includes first through fifth sub-modular arithmetic units 210(1)_1-210(1)_5 corresponding to the first through fifth moduli m1-m5, respectively. The first through fifth sub-modular arithmetic units 210(1)_1-210(1)_5 commonly receive a first unsigned weight data W1<6:0> and a first unsigned vector data V1<6:0>. The first through fifth sub-modular arithmetic units 210(1)_1-210(1)_5 perform first through fifth sub-modular operations on the first unsigned weight data W1<6:0> and the first unsigned vector data V1<6:0> by using the first through fifth moduli m1-m5, respectively. The first through fifth sub-modular operations may be performed in the same manner as the modular operations described with reference to FIG. 3.

Specifically, the first sub-modular arithmetic unit 210(1)_1 performs first sub-modular operations on the first unsigned weight data W1<6:0> and the first unsigned vector data V1<6:0> by using the first modulus m1. As a result of the first sub-modular operations, the first sub-modular arithmetic unit 210(1)_1 outputs a first weight redundant residue number RRNW1_1<1:0> of the first weight redundant residue number set RRNW1 and a first vector redundant residue number RRNV1_1<1:0> of the first vector redundant residue number set RRNV1. In this example, because the first modulus m1 is decimal “3,” the first weight redundant residue number RRNW1_1<1:0> and the first vector redundant residue number RRNV1_1<1:0> each have a bit length of two, corresponding to [log₂3].

The second sub-modular arithmetic unit 210(1)_2 performs second sub-modular operations on the first unsigned weight data W1<6:0> and the first unsigned vector data V1<6:0> by using the second modulus m2. As a result of the second sub-modular operations, the second sub-modular arithmetic unit 210(1)_2 outputs a second weight redundant residue number RRNW1_2<1:0> of the first weight redundant residue number set RRNW1 and a second vector redundant residue number RRNV1_2<1:0> of the first vector redundant residue number set RRNV1. In this example, because the second modulus m2 is decimal “4,” the second weight redundant residue number RRNW1_2<1:0> and the second vector redundant residue number RRNV1_2<1:0> each have a bit length of two, corresponding to [log₂4].

The third sub-modular arithmetic unit 210(1)_3 performs third sub-modular operations on the first unsigned weight data W1<6:0> and the first unsigned vector data V1<6:0> by using the third modulus m3. As a result of the third sub-modular operations, the third sub-modular arithmetic unit 210(1)_3 outputs a third weight redundant residue number RRNW1_3<2:0> of the first weight redundant residue number set RRNW1 and a third vector redundant residue number RRNV1_3<2:0> of the first vector redundant residue number set RRNV1. In this example, because the third modulus m3 is decimal “5,” the third weight redundant residue number RRNW1_3<2:0> and the third vector redundant residue number RRNV1_3<2:0> each have a bit length of three, corresponding to [log₂5].

The fourth sub-modular arithmetic unit 210(1)_4 performs fourth sub-modular operations on the first unsigned weight data W1<6:0> and the first unsigned vector data V1<6:0> by using the fourth modulus m4. As a result of the fourth sub-modular operations, the fourth sub-modular arithmetic unit 210(1)_4 outputs a fourth weight redundant residue number RRNW1_4<2:0> of the first weight redundant residue number set RRNW1 and a fourth vector redundant residue number RRNV1_4<2:0> of the first vector redundant residue number set RRNV1. In this example, because the fourth modulus m4 is decimal “7,” the fourth weight redundant residue number RRNW1_4<2:0> and the fourth vector redundant residue number RRNV1_4<2:0> each have a bit length of three, corresponding to [log₂7].

The fifth sub-modular arithmetic unit 210(1)_5 performs fifth sub-modular operations on the first unsigned weight data W1<6:0> and the first unsigned vector data V1<6:0> by using the fifth modulus m5. As a result of the fifth sub-modular operations, the fifth sub-modular arithmetic unit 210(1)_5 outputs a fifth weight redundant residue number RRNW1_5<3:0> of the first weight redundant residue number set RRNW1 and a fifth vector redundant residue number RRNV1_5<3:0> of the first vector redundant residue number set RRNV1. In this example, because the fifth modulus m5 is decimal “11,” the fifth weight redundant residue number RRNW1_5<3:0> and the fifth vector redundant residue number RRNV1_5<3:0> each have a bit length of four, corresponding to [log₂11].

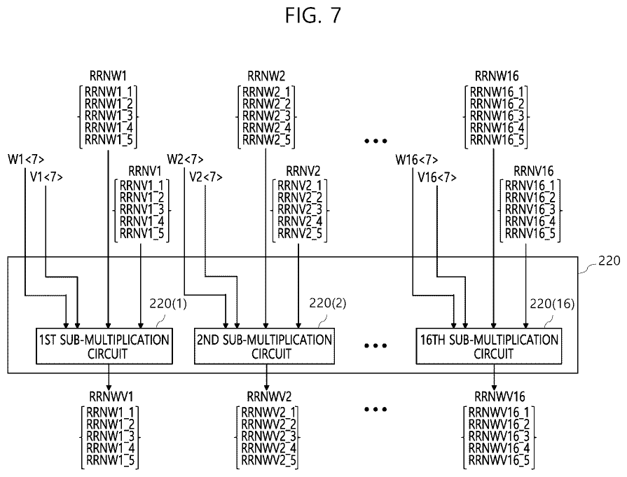

FIG. 7 is a block diagram illustrating an example of a multiplication circuit included in the processing unit of FIG. 4.

Referring to FIG. 7, a multiplication circuit 220 receives first through sixteenth sign bits W1<7>-W16<7> of the weight data and first through sixteenth sign bits V1<7>-V16<7> of the vector data, that are output from the redundant residue number generation circuit 210. In addition, the multiplication circuit 220 receives first through sixteenth weight redundant residue number sets RRNW1-RRNW16 and first through sixteenth vector redundant residue number sets RRNV1-RRNV16, that are output from the redundant residue number generation circuit 210. As described with reference to FIGS. 5 and 6, each of the first through sixteenth weight redundant residue number sets RRNW1-RRNW16 includes first through fifth weight redundant residue numbers, and each of the first through sixteenth vector redundant residue number sets RRNV1-RRNV16 includes first through fifth vector redundant residue numbers.

The multiplication circuit 220 performs first through sixteenth sign-processing operations and first through sixteenth multiplication operations. The first through sixteenth sign-processing operations are respectively performed on the first through sixteenth sign bits W1<7>-W16<7> of the weight data and the first through sixteenth sign bits V1<7>-V16<7> of the vector data. By performing the first through sixteenth sign-processing operations, first through sixteenth multiplication sign bits are generated.

The first through sixteenth multiplication operations are respectively performed on the first through sixteenth weight redundant residue number sets RRNW1-RRNW16 and the first through sixteenth vector redundant residue number sets RRNV1-RRNV16. The multiplication circuit 220 adds the respective first through sixteenth multiplication sign bits to the result data of the first through sixteenth multiplication operations, and generates and outputs first through sixteenth multiplication redundant residue number sets RRNW1-RRNW16. Each of the first through sixteenth multiplication redundant residue number sets RRNW1-RRNW16 includes first through fifth multiplication redundant residue numbers.

In one embodiment, the multiplication circuit 220 may include first through sixteenth sub-multiplication circuits 220(1)-220(16). The first through sixteenth sub-multiplication circuits 220(1)-220(16) respectively receive the sign bits W1<7>-W16<7> of the first through sixteenth weight data. The first through sixteenth sub-multiplication circuits 220(1)-220(16) respectively receive the sign bits V1<7>-V16<7> of the first through sixteenth vector data. The first through sixteenth sub-multiplication circuits 220(1)-220(16) respectively receive the first through sixteenth weight redundant residue number sets RRNW1-RRNW16. The first through sixteenth sub-multiplication circuits 220(1)-220(16) also respectively receive the first through sixteenth vector redundant residue number sets RRNV1-RRNV16.

For example, as illustrated in FIG. 7, the first sub-multiplication circuit 220(1) receives the sign bit W1<7> of the first weight data, the sign bit V1<7> of the first vector data, first through fifth weight redundant residue numbers RRNW1_1-RRNW1_5 included in the first weight redundant residue number set RRNW1, and first through fifth vector redundant residue numbers RRNV1_1-RRNV1_5 included in the first vector redundant residue number set RRNV1.

Similarly, the second sub-multiplication circuit 220(2) receives the sign bit W2<7> of the second weight data, the sign bit V2<7> of the second vector data, first through fifth weight redundant residue numbers RRNW2_1-RRNW2_5 included in the second weight redundant residue number set RRNW2, and first through fifth vector redundant residue numbers RRNV2_1-RRNV2_5 included in the second vector redundant residue number set RRNV2.

Likewise, the sixteenth sub-multiplication circuit 220(16) receives the sign bit W16<7> of the sixteenth weight data, the sign bit V16<7> of the sixteenth vector data, first through fifth weight redundant residue numbers RRNW16_1-RRNW16_5 included in the sixteenth weight redundant residue number set RRNW16, and first through fifth vector redundant residue numbers RRNV16_1-RRNV16_5 included in the sixteenth vector redundant residue number set RRNV16.

Among the first through sixteenth sub-multiplication circuits 220(1)-220(16), a K-th sub-multiplication circuit 220(K) (where K is a natural number from 1 to 16) performs a K-th sign-bit processing operation on the sign bit W″K″<7> of the K-th weight data and the sign bit V″K″<7> of the K-th vector data, and generates a K-th multiplication sign bit.

The K-th sub-multiplication circuit 220(K) performs first through fifth sub-multiplication operations on the first through fifth weight redundant residues RRNW″K_1″-RRNW″K_5″ included in the K-th weight redundant residue number set RRNW″K″, and the first through fifth vector redundant residues RRNV″K_1″-RRNV″K_5″ included in the K-th vector redundant residue number set RRNV″K″.

The K-th sub-multiplication circuit 220(K) appends the K-th multiplication sign bit to the result data of the first through fifth sub-multiplication operations, and outputs the first through fifth multiplication redundant residues RRNWV″K_1″-RRNWV″K_5″ included in the K-th multiplication redundant residue number set RRNWV″K″.

Specifically, a first sub-multiplication circuit 220(1) performs a first sign-bit processing operation on the sign bit W1<7> of the first weight data and the sign bit V1<7> of the first vector data, and generates a first multiplication sign bit. The first sub-multiplication circuit 220(1) performs a first sub-multiplication operation on a first weight redundant residue RRNW1_1 included in the first weight redundant residue number set RRNW1 and a first vector redundant residue RRNV1_1 included in the first vector redundant residue number set RRNV1. The circuit appends the first multiplication sign bit to the result of the first sub-multiplication operation and outputs a first multiplication redundant residue RRNWV1_1 included in the first multiplication redundant residue number set RRNWV1.

The first sub-multiplication circuit 220(1) performs a second sub-multiplication operation on a second weight redundant residue RRNW1_2 and a second vector redundant residue RRNV1_2. The circuit appends the first multiplication sign bit to the result of the second sub-multiplication operation and outputs a second multiplication redundant residue RRNWV1_2.

The first sub-multiplication circuit 220(1) performs a third sub-multiplication operation on a third weight redundant residue RRNW1_3 and a third vector redundant residue RRNV1_3. The circuit appends the first multiplication sign bit to the result of the third sub-multiplication operation and outputs a third multiplication redundant residue RRNWV1_3.

The first sub-multiplication circuit 220(1) performs a fourth sub-multiplication operation on a fourth weight redundant residue RRNW1_4 and a fourth vector redundant residue RRNV1_4. The circuit appends the first multiplication sign bit to the result of the fourth sub-multiplication operation and outputs a fourth multiplication redundant residue RRNWV1_4.

The first sub-multiplication circuit 220(1) performs a fifth sub-multiplication operation on a fifth weight redundant residue RRNW1_5 and a fifth vector redundant residue RRNV1_5. The circuit appends the first multiplication sign bit to the result of the fifth sub-multiplication operation and outputs a fifth multiplication redundant residue RRNWV1_5.

The second sub-multiplication circuit 220(2) performs a second sign-bit processing operation on the sign bit W2<7> of the second weight data and the sign bit V2<7> of the second vector data, and generates a second multiplication sign bit. The second sub-multiplication circuit 220(2) performs a first sub-multiplication operation on a first weight redundant residue RRNW2_1 included in the second weight redundant residue number set RRNW2 and a first vector redundant residue RRNV2_1 included in the second vector redundant residue number set RRNV2. The second sub-multiplication circuit 220(2) appends the second multiplication sign bit to the result of the first sub-multiplication operation and outputs a first multiplication redundant residue RRNWV2_1 included in the second multiplication redundant residue number set RRNWV2.

The second sub-multiplication circuit 220(2) performs a second sub-multiplication operation on a second weight redundant residue RRNW2_2 included in the second weight redundant residue number set RRNW2 and a second vector redundant residue RRNV2_2 included in the second vector redundant residue number set RRNV2. The second sub-multiplication circuit 220(2) appends the second multiplication sign bit to the result of the second sub-multiplication operation and outputs a second multiplication redundant residue RRNWV2_2 included in the second multiplication redundant residue number set RRNWV2.

The second sub-multiplication circuit 220(2) performs a third sub-multiplication operation on a third weight redundant residue RRNW2_3 included in the second weight redundant residue number set RRNW2 and a third vector redundant residue RRNV2_3 included in the second vector redundant residue number set RRNV2. The second sub-multiplication circuit 220(2) appends the second multiplication sign bit to the result of the third sub-multiplication operation and outputs a third multiplication redundant residue RRNWV2_3 included in the second multiplication redundant residue number set RRNWV2.

The second sub-multiplication circuit 220(2) performs a fourth sub-multiplication operation on a fourth weight redundant residue RRNW2_4 included in the second weight redundant residue number set RRNW2 and a fourth vector redundant residue RRNV2_4 included in the second vector redundant residue number set RRNV2. The second sub-multiplication circuit 220(2) appends the second multiplication sign bit to the result of the fourth sub-multiplication operation and outputs a fourth multiplication redundant residue RRNWV2_4 included in the second multiplication redundant residue number set RRNWV2.

The second sub-multiplication circuit 220(2) performs a fifth sub-multiplication operation on a fifth weight redundant residue RRNW2_5 included in the second weight redundant residue number set RRNW2 and a fifth vector redundant residue RRNV2_5 included in the second vector redundant residue number set RRNV2. The second sub-multiplication circuit 220(2) appends the second multiplication sign bit to the result of the fifth sub-multiplication operation and outputs a fifth multiplication redundant residue RRNWV2_5 included in the second multiplication redundant residue number set RRNWV2.

In the same manner, the sixteenth sub-multiplication circuit 220(16) performs a sixteenth sign-bit processing operation on a sign bit W16<7> of a sixteenth weight data and a sign bit V16<7> of a sixteenth vector data to generate a sixteenth multiplication sign bit. The sixteenth sub-multiplication circuit 220(16) performs a first sub-multiplication operation on a first weight redundant residue RRNW16_1 included in a sixteenth weight redundant residue number set RRNW16 and a first vector redundant residue RRNV16_1 included in a sixteenth vector redundant residue number set RRNV16. The sixteenth sub-multiplication circuit 220(16) appends the sixteenth multiplication sign bit to the result of the first sub-multiplication operation and outputs a first multiplication redundant residue RRNWV16_1 included in a sixteenth multiplication redundant residue number set RRNWV16.

The sixteenth sub-multiplication circuit 220(16) performs a second sub-multiplication operation on a second weight redundant residue RRNW16_2 included in a sixteenth weight redundant residue number set RRNW16 and a second vector redundant residue RRNV16_2 included in a sixteenth vector redundant residue number set RRNV16. The sixteenth sub-multiplication circuit 220(16) appends the sixteenth multiplication sign bit to the result of the second sub-multiplication operation and outputs a second multiplication redundant residue RRNWV16_2 included in a sixteenth multiplication redundant residue number set RRNWV16.

The sixteenth sub-multiplication circuit 220(16) performs a third sub-multiplication operation on a third weight redundant residue RRNW16_3 included in a sixteenth weight redundant residue number set RRNW16 and a third vector redundant residue RRNV16_3 included in a sixteenth vector redundant residue number set RRNV16. The sixteenth sub-multiplication circuit 220(16) appends a sixteenth multiplication sign bit to the result of the third sub-multiplication operation and outputs a third multiplication redundant residue RRNWV16_3 included in a sixteenth multiplication redundant residue number set RRNWV16.

The sixteenth sub-multiplication circuit 220(16) performs a fourth sub-multiplication operation on a fourth weight redundant residue RRNW16_4 included in a sixteenth weight redundant residue number set RRNW16 and a fourth vector redundant residue RRNV16_4 included in a sixteenth vector redundant residue number set RRNV16. The sixteenth sub-multiplication circuit 220(16) appends a sixteenth multiplication sign bit to the result of the fourth sub-multiplication operation and outputs a fourth multiplication redundant residue RRNWV16_4 included in a sixteenth multiplication redundant residue number set RRNWV16.

The sixteenth sub-multiplication circuit 220(16) performs a fifth sub-multiplication operation on a fifth weight redundant residue RRNW16_5 included in a sixteenth weight redundant residue number set RRNW16 and a fifth vector redundant residue RRNV16_5 included in a sixteenth vector redundant residue number set RRNV16. The sixteenth sub-multiplication circuit 220(16) appends a sixteenth multiplication sign bit to the result of the fifth sub-multiplication operation and outputs a fifth multiplication redundant residue RRNWV16_5 included in a sixteenth multiplication redundant residue number set RRNWV16.

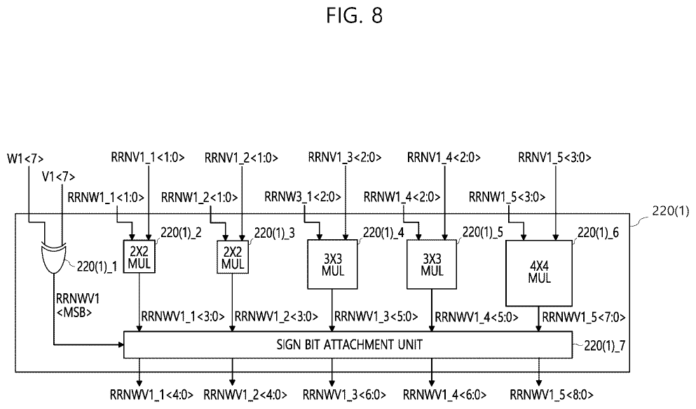

FIG. 8 is a diagram illustrating an example of a first multiplication circuit included in the multiplication circuit of FIG. 7. The following description of the first multiplication circuit may equally apply to second through sixteenth multiplication circuits included in the multiplication circuit 220 of FIG. 7. In this example, decimal numbers “3,” “4,” “5,” “7,” and “11” are assumed as the first through fifth moduli (m1, m2, m3, m4, m5). However, this is merely one embodiment and is not limited thereto, and the first through fifth moduli (m1, m2, m3, m4, m5) may be variously set.

Referring to FIG. 8, the first multiplication circuit 220(1) includes an exclusive-OR (XOR) operator 220(1)_1, first through fifth multipliers 220(1)_2-220(1)_6, and a sign bit appending unit 220(1)_7. The XOR operator 220(1)_1 receives a sign bit W1<7> of the first weight data and a sign bit V1<7> of the first vector data through a first input terminal and a second input terminal, respectively. As a first sign processing operation, the XOR operator 220(1)_1 performs an XOR operation on the sign bit W1<7> of the first weight data and the sign bit V1<7> of the first vector data. The XOR operator 220(1)_1 outputs the result data of the XOR operation as a first multiplication sign bit RRNWV1<MSB>.

The first through fifth multipliers 220(1)_2-220(1)_6 respectively receive first through fifth weight redundant residues RRNW1_1<1:0>-RRNW1_5<2:0> included in the first weight redundant residue set RRNW1. The first through fifth multipliers 220(1)_2-220(1)_6 also respectively receive first through fifth vector redundant residues RRNV1_1<1:0>-RRNV1_5<2:0> included in the first vector redundant residue set RRNV1.

Specifically, a first multiplier 220(1)_2 receives a first weight redundant residue RRNW1_1<1:0> included in the first weight redundant residue set RRNW1 and a first vector redundant residue RRNV1_1<1:0> included in the first vector redundant residue set RRNV1. A second multiplier 220(1)_3 receives a second weight redundant residue RRNW1_2<1:0> included in the first weight redundant residue set RRNW1 and a second vector redundant residue RRNV1_2<1:0> included in the first vector redundant residue set RRNV1. A third multiplier 220(1)_4 receives a third weight redundant residue RRNW1_3<2:0> included in the first weight redundant residue set RRNW1 and a third vector redundant residue RRNV1_3<2:0> included in the first vector redundant residue set RRNV1. A fourth multiplier 220(1)_5 receives a fourth weight redundant residue RRNW1_4<2:0> included in the first weight redundant residue set RRNW1 and a fourth vector redundant residue RRNV1_4<2:0> included in the first vector redundant residue set RRNV1. A fifth multiplier 220(1)_6 receives a fifth weight redundant residue RRNW1_5<3:0> included in the first weight redundant residue set RRNW1 and a fifth vector redundant residue RRNV1_5<3:0> included in the first vector redundant residue set RRNV1.

Because the first weight redundant residue RRNW1_1<1:0> and the first vector redundant residue RRNV1_1<1:0>, that are generated using a first modulus m1=3, each have a size of 2 bits, a first multiplier 220(1)_2 has a size of 2×2. Because the second weight redundant residue RRNW1_2<1:0> and the second vector redundant residue RRNV1_2<1:0>, that are generated using a second modulus m2=4, also each have a size of 2 bits, a second multiplier 220(1)_3 likewise has a size of 2×2. Because the third weight redundant residue RRNW1_3<2:0> and the third vector redundant residue RRNV1_3<2:0>, that are generated using a third modulus m3=5, each have a size of 3 bits, a third multiplier 220(1)_4 has a size of 3×3. Because the fourth weight redundant residue RRNW1_4<2:0> and the fourth vector redundant residue RRNV1_4<2:0>, that are generated using a fourth modulus m4=7, also each have a size of 3 bits, a fourth multiplier 220(1)_5 likewise has a size of 3×3. Because the fifth weight redundant residue RRNW1_5<3:0> and the fifth vector redundant residue RRNV1_5<3:0>, that are generated using a fifth modulus m5=11, each have a size of 4 bits, a fifth multiplier 220(1)_6 has a size of 4×4.

A first multiplier 220(1)_2 performs a first sub-multiplication operation on a first weight redundant residue RRNW1_1<1:0> and a first vector redundant residue RRNV1_1<1:0>, and generates a first multiplication redundant residue RRNWV1_1<3:0> having 4 bits. A second multiplier 220(1)_3 performs a second sub-multiplication operation on a second weight redundant residue RRNW1_2<1:0> and a second vector redundant residue RRNV1_2<1:0>, and generates a second multiplication redundant residue RRNWV1_2<3:0> having 4 bits. A third multiplier 220(1)_4 performs a third sub-multiplication operation on a third weight redundant residue RRNW1_3<2:0> and a third vector redundant residue RRNV1_3<2:0>, and generates a third multiplication redundant residue RRNWV1_3<5:0> having 6 bits. A fourth multiplier 220(1)_5 performs a fourth sub-multiplication operation on a fourth weight redundant residue RRNW1_4<2:0> and a fourth vector redundant residue RRNV1_4<2:0>, and generates a fourth multiplication redundant residue RRNWV1_4<5:0> having 6 bits. A fifth multiplier 220(1)_6 performs a fifth sub-multiplication operation on a fifth weight redundant residue RRNW1_5<3:0> and a fifth vector redundant residue RRNV1_5<3:0>, and generates a fifth multiplication redundant residue RRNWV1_5<7:0> having 8 bits.

The first through fifth weight redundant residues RRNW1_1<1:0>-RRNW1_5<3:0> and the first through fifth vector redundant residues RRNV1_1<1:0>-RRNV1_5<3:0>, that are input to the first through fifth multipliers 220(1)_2-220(1)_6, do not include sign bits. Because of this, the first through fifth multiplication redundant residues RRNWV1_1<3:0>-RRNWV1_5<7:0>, that are generated by the first through fifth sub-multiplication operations performed in the first through fifth multipliers 220(1)_2-220(1)_6, also do not include sign bits. Although sign bits are not required in the multiplication operation, the subsequent addition operation produces different results depending on the values of the sign bits.

The sign bit appending unit 220(1)_7 appends a sign bit RRNWV1<MSB> to the first through fifth multiplication redundant residues RRNWV1_1<3:0>-RRNWV1_5<7:0> and outputs the resulting values. Specifically, the sign bit appending unit 220(1)_7 receives the first multiplication sign bit RRNWV1<MSB> output from the XOR operator 220(1)_1. The sign bit appending unit 220(1)_7 also receives the first through fifth multiplication redundant residues RRNWV1_1<3:0>-RRNWV1_5<7:0> output from the first through fifth multipliers 220(1)_2-220(1)_6. For each of the first through fifth multiplication redundant residues RRNWV1_1<3:0>-RRNWV1_5<7:0>, the sign bit appending unit 220(1)_7 appends the first multiplication sign bit RRNWV1<MSB> as the most significant bit (MSB). The sign bit appending unit 220(1)_7 outputs a first multiplication redundant residue RRNWV1_1<4:0>, a second multiplication redundant residue RRNWV1_2<4:0>, a third multiplication redundant residue RRNWV1_3<6:0>, a fourth multiplication redundant residue RRNWV1_4<6:0>, and a fifth multiplication redundant residue RRNWV1_5<8:0>, each having the first multiplication sign bit RRNWV1<MSB> appended as the MSB.

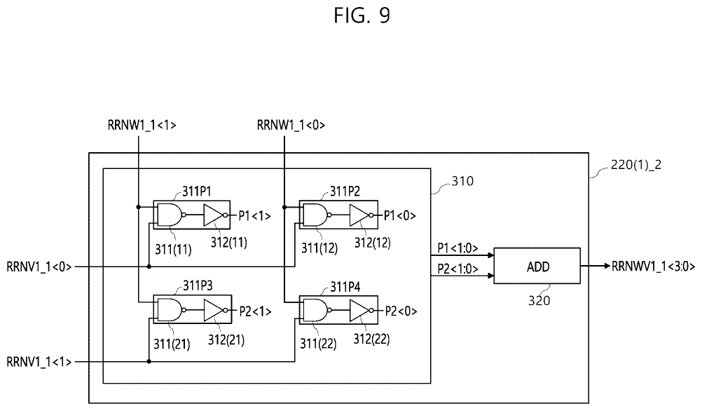

FIG. 9 is a diagram illustrating an example of a first multiplier included in the first multiplication circuit of FIG. 8. The description of the first multiplier in this example may also be equally applied to a second multiplier included in the first multiplication circuit 220(1) of FIG. 8.

Referring to FIG. 9, the first multiplier 2201_2 may include an AND array block 310 and an adder 320. The AND array block 310 receives the first weight redundant residue RRNW1_1 and the first vector redundant residue RRNV1_1. The AND array block 310 performs AND operations on the bits of the first weight redundant residue RRNW1_1 and the bits of the first vector redundant residue RRNV1_1, and outputs first partial product data P1<1:0> and second partial product data P2<1:0>. The adder 320 receives the first partial product data P1<1:0> and the second partial product data P2<1:0> output from the AND array block 310. The adder 320 performs an addition operation on the first partial product data P1<1:0> and the second partial product data P2<1:0>, and generates and outputs a first multiplication redundant residue RRNWV1_1<3:0>.

More specifically, the AND array block 310 may include a plurality of NAND gate-inverter pairs 311P1-311P4 arranged in an array form. The array size of the AND array block 310 may be determined according to the number of bits of the first weight redundant residue RRNW1_1 and the first vector redundant residue RRNV1_1 that are input to the first multiplier 2201_2. Because the first multiplier 2201_2 receives the 2-bit first weight redundant residue RRNW1_1<1:0> and the 2-bit first vector redundant residue RRNV1_1<1:0>, the array has a 2×2 size. Therefore, the AND array block 310 includes the first to fourth NAND gate-inverter pairs 311P1-311P4.

The first to fourth NAND gate-inverter pairs 311P1-311P4 are configured such that a NAND gate and an inverter are serially connected. That is, the output terminal of the NAND gate constituting each of the first to fourth NAND gate-inverter pairs 311P1-311P4 is connected to the input terminal of the inverter. Each of the first to fourth NAND gate-inverter pairs 311P1-311P4 may sequentially perform a NAND logic operation and an inversion operation on data input to the NAND gate. In other words, each of the first to fourth NAND gate-inverter pairs 311P1-311P4 performs an AND logic operation.

In the first row and first column of the AND array block 310, a first NAND gate-inverter pair 311P1, that is composed of a first NAND gate 31111 and a first inverter 31211, is disposed. In the first row and second column of the AND array block 310, a second NAND gate-inverter pair 311P2, that is composed of a second NAND gate 31112 and a second inverter 31212, is disposed. In the second row and first column of the AND array block 310, a third NAND gate-inverter pair 311P3, that is composed of a third NAND gate 31121 and a third inverter 31221, is disposed. In the second row and second column of the AND array block 310, a fourth NAND gate-inverter pair 311P4, that is composed of a fourth NAND gate 31122 and a fourth inverter 31222, is disposed.

The first NAND gate 31111 receives the second bit of the first weight redundant residue RRNW1_1<1> through a first input terminal, and receives the first bit of the first vector redundant residue RRNV1_1<0> through a second input terminal. The first NAND gate 31111 performs a NAND operation on the second bit of the first weight redundant residue RRNW1_1<1> and the first bit of the first vector redundant residue RRNV1_1<0>, and transmits the result data to an input terminal of the first inverter 31211. The first inverter 31211 inverts the result data received from the first NAND gate 31111 and outputs the second bit P1<1> of the first partial product data.

The second NAND gate 31112 receives the first bit of the first weight redundant residue RRNW1_1<0> through a first input terminal, and receives the first bit of the first vector redundant residue RRNV1_1<0> through a second input terminal. The second NAND gate 31112 performs a NAND operation on the first bit of the first weight redundant residue RRNW1_1<0> and the first bit of the first vector redundant residue RRNV1_1<0>, and transmits the result data to an input terminal of the second inverter 31212. The second inverter 31212 inverts the result data received from the second NAND gate 31112 and outputs the first bit P1<0> of the first partial product data.

The third NAND gate 31121 receives the second bit of the first weight redundant residue RRNW1_1<1> through a first input terminal, and receives the second bit of the first vector redundant residue RRNV1_1<1> through a second input terminal. The third NAND gate 31121 performs a NAND operation on the second bit of the first weight redundant residue RRNW1_1<1> and the second bit of the first vector redundant residue RRNV1_1<1>, and transmits the result data to an input terminal of the third inverter 31221. The third inverter 31221 inverts the result data received from the third NAND gate 31121 and outputs the second bit P2<1> of the second partial product data.

The fourth NAND gate 31122 receives the first bit of the first weight redundant residue RRNW1_1<0> through a first input terminal, and receives the second bit of the first vector redundant residue RRNV1_1<1> through a second input terminal. The fourth NAND gate 31122 performs a NAND operation on the first bit of the first weight redundant residue RRNW1_1<0> and the second bit of the first vector redundant residue RRNV1_1<1>, and transmits the result data to an input terminal of the fourth inverter 31222. The fourth inverter 31222 inverts the result data received from the fourth NAND gate 31122 and outputs the first bit P2<0> of the second partial product data.

The adder 320 receives the first partial product data P1<1:0> and the second partial product data P2<1:0> output from the AND array block 310 through first and second input terminals, respectively. Although the first partial product data P1<1:0> and the second partial product data P2<1:0> each have a size of two bits, a lower-order bit of “0” is added to the second partial product data P2<1:0> before the addition operation is performed. Therefore, the adder 320 has a size capable of performing an addition operation on two three-bit data, i.e., a size of at least 3×2. For example, when both the first partial product data P1<1:0> and the second partial product data P2<1:0> are “01,” the adder 320 performs an addition operation of “01+010.” Accordingly, the result data of the addition operation output from the adder 320 has a size of four bits including a carry bit. The adder 320 generates and outputs the first multiplication redundant residue RRNWV1<3:0> as the result of the addition operation. In one example, the adder 320 may be a prefix adder, such as a Kogge-Stone adder, in which the concept of a carry-generate logic (G) that generates a carry in the corresponding bit and a carry-propagate logic (P) that propagates the carry of the corresponding bit is introduced.

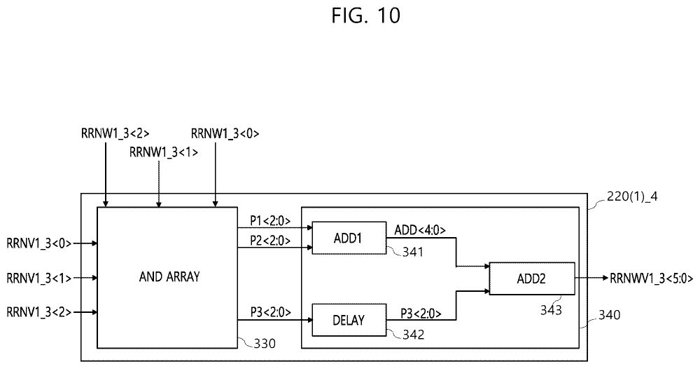

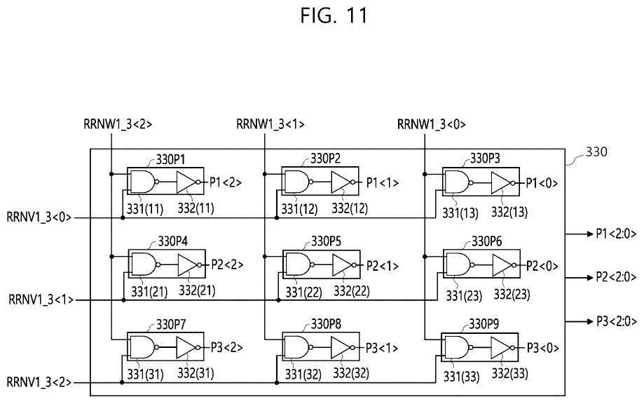

FIG. 10 is a diagram illustrating an example of a third multiplier included in the first multiplication circuit of FIG. 8. And FIG. 11 is a circuit diagram illustrating an AND array block of the third multiplier of FIG. 10 according to an embodiment of the present disclosure. The description of the third multiplier in this example may also be equally applied to the fourth multiplier included in the first multiplication circuit of FIG. 8.

Referring first to FIG. 10, the third multiplier 220_1_4 includes an AND array block 330 and an addition block 340. The addition block 340 includes a first adder 341, a delay element 342, and a second adder 343. The AND array block 330 receives a third weight redundant residue RRNW1_3<2:0> and a third vector redundant residue RRNV1_3<2:0>. The AND array block 330 performs AND operations on the bits of the third weight redundant residue RRNW1_3<2:0> and the bits of the third vector redundant residue RRNV1_3<2:0>, and outputs first partial product data P1<2:0>, second partial product data P2<2:0>, and third partial product data P3<2:0>. The addition block 340 receives the first partial product data P1<2:0>, the second partial product data P2<2:0>, and the third partial product data P3<2:0> from the AND array block 330. The addition block 340 performs an addition operation on the first partial product data P1<2:0>, the second partial product data P2<2:0>, and the third partial product data P3<2:0>, and may generate and output a third multiplication redundant residue RRNWV1_3<5:0> included in the first multiplication redundant residue set.

As shown in FIG. 11, the AND array block 330 included in the third multiplier 220_1_4 includes first through ninth NAND gate-inverter pairs 330P1-330P9 arranged in an array form. Because the third multiplier 220_1_4 receives a third weight redundant residue RRNW1_3<2:0> of 3 bits and a third vector redundant residue RRNV1_3<2:0> of 3 bits, the array of the AND array block 330 has a 3×3 size. The first through third NAND gate-inverter pairs 330P1-330P3 are arranged in a first row of the array. The fourth through sixth NAND gate-inverter pairs 330P4-330P6 are arranged in a second row of the array. The seventh through ninth NAND gate-inverter pairs 330P7-330P9 are arranged in a third row of the array.

The first through third NAND gate-inverter pairs 330P1-330P3 are respectively arranged in first through third columns of a first row of the array. The first NAND gate-inverter pair 330P1 includes a first NAND gate 331(11) and a first inverter 332(11) coupled in series with each other. The second NAND gate-inverter pair 330P2 includes a second NAND gate 331(12) and a second inverter 332(12) coupled in series with each other. The third NAND gate-inverter pair 330P3 includes a third NAND gate 331(13) and a third inverter 332(13) coupled in series with each other.

The fourth through sixth NAND gate-inverter pairs 330P4-330P6 are respectively arranged in first through third columns of a second row of the array. The fourth NAND gate-inverter pair 330P4 includes a fourth NAND gate 331(21) and a fourth inverter 332(21) coupled in series with each other. The fifth NAND gate-inverter pair 330P5 includes a fifth NAND gate 331(22) and a fifth inverter 332(22) coupled in series with each other. The sixth NAND gate-inverter pair 330P6 includes a sixth NAND gate 331(23) and a sixth inverter 332(23) coupled in series with each other.

The seventh through ninth NAND gate-inverter pairs 330P7-330P9 are respectively arranged in first through third columns of a third row of the array. The seventh NAND gate-inverter pair 330P7 includes a seventh NAND gate 331(31) and a seventh inverter 332(31) coupled in series with each other. The eighth NAND gate-inverter pair 330P8 includes an eighth NAND gate 331(32) and an eighth inverter 332(32) coupled in series with each other. The ninth NAND gate-inverter pair 330P9 includes a ninth NAND gate 331(33) and a ninth inverter 332(33) coupled in series with each other.

The first through third NAND gate-inverter pairs 330P1-330P3, that are arranged in the first row of the array, respectively receive bits of the third weight redundant residue RRNW1_3<2:0> through first input terminals. The first through third NAND gate-inverter pairs 330P1-330P3 commonly receive a first bit of the third vector redundant residue RRNV1_3<0> through second input terminals.

A first NAND gate 331(11) performs a NAND operation on a third bit of the third weight redundant residue RRNW1_3<2> and the first bit of the third vector redundant residue RRNV1_3<0>. A first inverter 332(11) inverts result data of the NAND operation performed by the first NAND gate 331(11) and outputs a third bit of first partial product data P1<2>.

A second NAND gate 331(12) performs a NAND operation on a second bit of the third weight redundant residue RRNW1_3<1> and the first bit of the third vector redundant residue RRNV1_3<0>. A second inverter 332(12) inverts result data of the NAND operation performed by the second NAND gate 331(12) and outputs a second bit of the first partial product data P1<1>.

A third NAND gate 331(13) performs a NAND operation on a first bit of the third weight redundant residue RRNW1_3<0> and the first bit of the third vector redundant residue RRNV1_3<0>. A third inverter 332(13) inverts result data of the NAND operation performed by the third NAND gate 331(13) and outputs a first bit of the first partial product data P1<0>.

The fourth through sixth NAND gate-inverter pairs 330P4-330P6, that are arranged in the second row of the array, respectively receive bits of the third weight redundant residue RRNW1_3<2:0> through first input terminals. The fourth through sixth NAND gate-inverter pairs 330P4-330P6 commonly receive a second bit of the third vector redundant residue RRNV1_3<1> through second input terminals.

A fourth NAND gate 331(21) performs a NAND operation on a third bit of the third weight redundant residue RRNW1_3<2> and the second bit of the third vector redundant residue RRNV1_3<1>. A fourth inverter 332(21) inverts result data of the NAND operation performed by the fourth NAND gate 331(21) and outputs a third bit of second partial product data P2<2>.

A fifth NAND gate 331(22) performs a NAND operation on a second bit of the third weight redundant residue RRNW1_3<1>and the second bit of the third vector redundant residue RRNV1_3<1>. A fifth inverter 332(22) inverts result data of the NAND operation performed by the fifth NAND gate 331(22) and outputs a second bit of the second partial product data P2<1>.

A sixth NAND gate 331(23) performs a NAND operation on a first bit of the third weight redundant residue RRNW1_3<0> and the second bit of the third vector redundant residue RRNV1_3<1>. A sixth inverter 332(23) inverts result data of the NAND operation performed by the sixth NAND gate 331(23) and outputs a first bit of the second partial product data P2<0>.

The seventh through ninth NAND gate-inverter pairs 330P7-330P9, that are arranged in the third row of the array, respectively receive bits of the third weight redundant residue RRNW1_3<2:0> through first input terminals. The seventh through ninth NAND gate-inverter pairs 330P7-330P9 commonly receive a third bit of the third vector redundant residue RRNV1_3<2> through second input terminals.

A seventh NAND gate 331(31) performs a NAND operation on a third bit of the third weight redundant residue RRNW1_3<2> and the third bit of the third vector redundant residue RRNV1_3<2>. A seventh inverter 332(31) inverts result data of the NAND operation performed by the seventh NAND gate 331(31) and outputs a third bit of third partial product data P3<2>.

An eighth NAND gate 331(32) performs a NAND operation on a second bit of the third weight redundant residue RRNW1_3<1> and the third bit of the third vector redundant residue RRNV1_3<2>. An eighth inverter 332(32) inverts result data of the NAND operation performed by the eighth NAND gate 331(32) and outputs a second bit of the third partial product data P3<1>.

A ninth NAND gate 331(33) performs a NAND operation on a first bit of the third weight redundant residue RRNW1_3<0> and the third bit of the third vector redundant residue RRNV1_3<2>. A ninth inverter 332(33) inverts result data of the NAND operation performed by the ninth NAND gate 331(33) and outputs a first bit of the third partial product data P3<0>.

Referring again to FIG. 10, first partial product data P1<2:0> and second partial product data P2<2:0> output from the AND array block 330 are respectively transmitted to a first input terminal and a second input terminal of a first adder 341. Third partial product data P3<2:0> output from the AND array block 330 is transmitted to an input terminal of a delay unit 342. Although the first partial product data P1<2:0> and the second partial product data P2<2:0> have a size of three bits each, the first adder 341 performs an addition operation after a lower-order bit “0” is appended to the second partial product data P2<2:0>. Accordingly, the first adder 341 has a size capable of performing an addition operation on two four-bit data values, that is, at least a 4×2 size.

For example, when both the first partial product data P1<2:0> and the second partial product data P2<2:0> are “001,” the first adder 341 performs the addition operation of “001+0010.” As a result, output data of the addition operation from the first adder 341 has a size of five bits including a carry bit. The first adder 341 performs the addition operation on the first partial product data P1<2:0> and the second partial product data P2<2:0> and outputs addition data ADD<4:0>.

The delay unit 342 outputs the third partial product data P3<2:0> at a time point delayed from an input time point of the third partial product data P3<2:0>. A delay time of the delay unit 342 may be set to a time required for the first adder 341 to perform the addition operation on the first partial product data P1<2:0> and the second partial product data P2<2:0>. Accordingly, an output time point of the addition data ADD<4:0> from the first adder 341 and an output time point of the third partial product data P3<2:0> from the delay unit 342 may be synchronized.

A second adder 343 receives the addition data ADD<4:0> and the third partial product data P3<2:0> respectively from the first adder 341 and the delay unit 342. Although the addition data ADD<4:0> has a size of five bits and the third partial product data P3<2:0> has a size of three bits, the second adder 343 performs an addition operation after two lower-order bits “00” are appended to the third partial product data P3<2:0>. Accordingly, the second adder 343 has a size capable of performing an addition operation on two five-bit data values, that is, at least a 5×3 size.

For example, when the addition data ADD<4:0> and the third partial product data P3<2:0> are “00011” and “000,” respectively, the second adder 343 performs the addition operation of “00011+00000.” As a result, output data of the addition operation from the second adder 343 has a size of six bits including a carry bit. The second adder 343 performs the addition operation and outputs a third multiplication redundant residue RRNWV1_3<5:0> included in the first multiplication redundant residue set.

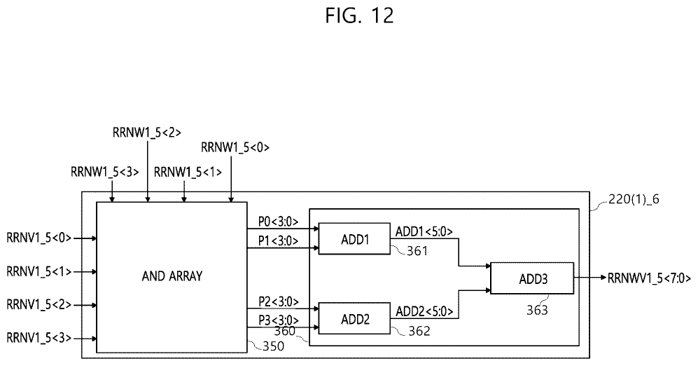

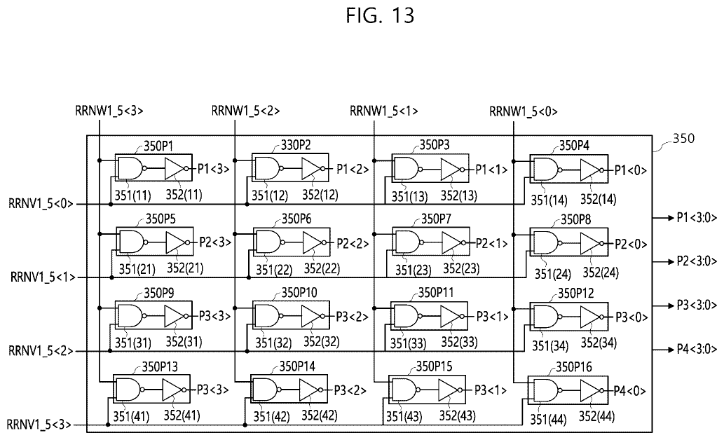

FIG. 12 is a diagram illustrating an example of a fifth multiplier included in the first multiplication circuit of FIG. 8. And FIG. 13 is a circuit diagram illustrating an AND array block of the fifth multiplier of FIG. 12 according to an embodiment of the present disclosure.

Referring first to FIG. 12, a fifth multiplier 2201_6 includes an AND array block 350 and an addition block 360. The addition block 360 includes a first adder 361, a second adder 362, and a third adder 363. The AND array block 350 receives a fifth weight redundant residue RRNW1_5<3:0> and a fifth vector redundant residue RRNV1_5<3:0>. The AND array block 350 performs AND operations on bits of the fifth weight redundant residue RRNW1_5<3:0> and bits of the fifth vector redundant residue RRNV1_5<3:0>, and outputs first partial product data P1<3:0>, second partial product data P2<3:0>, third partial product data P3<3:0>, and fourth partial product data P4<3:0>.

The addition block 360 receives the first partial product data P1<3:0>, the second partial product data P2<3:0>, the third partial product data P3<3:0>, and the fourth partial product data P4<3:0> output from the AND array block 350. The addition block 360 performs an addition operation on the first through fourth partial product data P1<3:0>-P4<3:0> and generates and outputs a fifth multiplication redundant residue RRNWV1_5<7:0> included in the first multiplication redundant residue set.

As illustrated in FIG. 13, an AND array block 350 included in the fifth multiplier 220(1)_6 includes first through sixteenth NAND gate-inverter pairs 350P1-350P16 arranged in an array form. Because the fifth multiplier 220(1)_6 receives a 4-bit fifth weight redundant residue RRNW1_5<3:0> and a 4-bit fifth vector redundant residue RRNV1_5<3:0>, the array of the AND array block 350 has a 4×4 size. The first through fourth NAND gate-inverter pairs 350P1-350P4 are arranged in a first row of the array. The fifth through eighth NAND gate-inverter pairs 350P5-350P8 are arranged in a second row of the array. The ninth through twelfth NAND gate-inverter pairs 350P9-350P12 are arranged in a third row of the array. The thirteenth through sixteenth NAND gate-inverter pairs 350P13-350P16 are arranged in a fourth row of the array.

The first through fourth NAND gate-inverter pairs 350P1-350P4 are respectively arranged in first through fourth columns of a first row of the array. The first NAND gate-inverter pair 350P1 includes a first NAND gate 351(11) and a first inverter 352(11) connected in series. The second NAND gate-inverter pair 350P2 includes a second NAND gate 351(12) and a second inverter 352(12) connected in series. The third NAND gate-inverter pair 350P3 includes a third NAND gate 351(13) and a third inverter 352(13) connected in series. The fourth NAND gate-inverter pair 350P4 includes a fourth NAND gate 351(14) and a fourth inverter 352(14) connected in series.

The fifth through eighth NAND gate-inverter pairs 350P5-350P8 are respectively arranged in first through fourth columns of a second row of the array. The fifth NAND gate-inverter pair 350P5 includes a fifth NAND gate 351(21) and a fifth inverter 352(21) connected in series. The sixth NAND gate-inverter pair 350P6 includes a sixth NAND gate 351(22) and a sixth inverter 352(22) connected in series. The seventh NAND gate-inverter pair 350P7 includes a seventh NAND gate 351(23) and a seventh inverter 352(23) connected in series. The eighth NAND gate-inverter pair 350P8 includes an eighth NAND gate 351(24) and an eighth inverter 352(24) connected in series.

The ninth through twelfth NAND gate-inverter pairs 350P9-350P12 are respectively arranged in first through fourth columns of a third row of the array. The ninth NAND gate-inverter pair 350P9 includes a ninth NAND gate 351(31) and a ninth inverter 352(31) connected in series. The tenth NAND gate-inverter pair 350P10 includes a tenth NAND gate 351(32) and a tenth inverter 352(32) connected in series. The eleventh NAND gate-inverter pair 350P11 includes an eleventh NAND gate 351(33) and an eleventh inverter 352(33) connected in series. The twelfth NAND gate-inverter pair 350P12 includes a twelfth NAND gate 351(34) and a twelfth inverter 352(34) connected in series.

The thirteenth through sixteenth NAND gate-inverter pairs 350P13-350P16 are respectively arranged in first through fourth columns of a fourth row of the array. The thirteenth NAND gate-inverter pair 350P13 includes a thirteenth NAND gate 351(41) and a thirteenth inverter 352(41) connected in series. The fourteenth NAND gate-inverter pair 350P14 includes a fourteenth NAND gate 351(42) and a fourteenth inverter 352(42) connected in series. The fifteenth NAND gate-inverter pair 350P15 includes a fifteenth NAND gate 351(43) and a fifteenth inverter 352(43) connected in series. The sixteenth NAND gate-inverter pair 350P16 includes a sixteenth NAND gate 351(44) and a sixteenth inverter 352(44) connected in series.

The first through fourth NAND gate-inverter pairs 351P1-351P4, that are arranged in a first row of the array, respectively receive bits of the fifth weight redundant residue RRNW1_5<3:0> through their first input terminals. The first through fourth NAND gate-inverter pairs 351P1-351P4 commonly receive a first bit RRNV1_5<0> of the fifth vector redundant residue through their second input terminals.

A first NAND gate 351(11) performs a NAND operation on a fourth bit RRNW1_5<3> of the fifth weight redundant residue and the first bit RRNV1_5<0> of the fifth vector redundant residue. A first inverter 352(11) inverts result data output from the first NAND gate 351(11) and outputs a fourth bit P1<3> of a first partial product data.

A second NAND gate 351(12) performs a NAND operation on a third bit RRNW1_5<2> of the fifth weight redundant residue and the first bit RRNV1_5<0> of the fifth vector redundant residue. A second inverter 352(12) inverts result data output from the second NAND gate 351(12) and outputs a third bit P1<2> of the first partial product data.

A third NAND gate 351(13) performs a NAND operation on a second bit RRNW1_5<1> of the fifth weight redundant residue and the first bit RRNV1_5<0> of the fifth vector redundant residue. A third inverter 352(13) inverts result data output from the third NAND gate 351(13) and outputs a second bit P1<1> of the first partial product data.

A fourth NAND gate 351(14) performs a NAND operation on a first bit RRNW1_5<0> of the fifth weight redundant residue and the first bit RRNV1_5<0> of the fifth vector redundant residue. A fourth inverter 352(14) inverts result data output from the fourth NAND gate 351(14) and outputs a first bit P1<0> of the first partial product data.

The fifth through eighth NAND gate-inverter pairs 351P5-351P8, that are arranged in a second row of the array, respectively receive bits of the fifth weight redundant residue RRNW1_5<3:0> through first input terminals. The fifth through eighth NAND gate-inverter pairs 351P5-351P8 commonly receive a second bit of the fifth vector redundant residue RRNV1_5<1> through second input terminals.

A fifth NAND gate 351(21) performs a NAND operation on a fourth bit of the fifth weight redundant residue RRNW1_5<3> and the second bit of the fifth vector redundant residue RRNV1_5<1>. A fifth inverter 352(21) inverts result data of the NAND operation performed by the fifth NAND gate 351(21) and outputs a fourth bit of a second partial product data P2<3>.

A sixth NAND gate 351(22) performs a NAND operation on a third bit of the fifth weight redundant residue RRNW1_5<2> and the second bit of the fifth vector redundant residue RRNV1_5<1>. A sixth inverter 352(22) inverts result data of the NAND operation performed by the sixth NAND gate 351(22) and outputs a third bit of the second partial product data P2<2>.

A seventh NAND gate 351(23) performs a NAND operation on a second bit of the fifth weight redundant residue RRNW1_5<1>and the second bit of the fifth vector redundant residue RRNV1_5<1>. A seventh inverter 352(23) inverts result data of the NAND operation performed by the seventh NAND gate 351(23) and outputs a second bit of the second partial product data P2<1>.

An eighth NAND gate 351(24) performs a NAND operation on a first bit of the fifth weight redundant residue RRNW1_5<0> and the second bit of the fifth vector redundant residue RRNV1_5<1>. An eighth inverter 352(24) inverts result data of the NAND operation performed by the eighth NAND gate 351(24) and outputs a first bit of the second partial product data P2<0>.

The ninth through twelfth NAND gate-inverter pairs 351P9-351P12, that are arranged in a third row of the array, respectively receive bits of the fifth weight redundant residue RRNW1_5<3:0> through first input terminals. The ninth through twelfth NAND gate-inverter pairs 351P9-351P12 commonly receive a third bit of the fifth vector redundant residue RRNV1_5<2> through second input terminals.

A ninth NAND gate 351(31) performs a NAND operation on a fourth bit of the fifth weight redundant residue RRNW1_5<3> and the third bit of the fifth vector redundant residue RRNV1_5<2>. A ninth inverter 352(31) inverts result data of the NAND operation performed by the ninth NAND gate 351(31) and outputs a fourth bit of a third partial product data P3<3>.

A tenth NAND gate 351(32) performs a NAND operation on a third bit of the fifth weight redundant residue RRNW1_5<2> and the third bit of the fifth vector redundant residue RRNV1_5<2>. A tenth inverter 352(32) inverts result data of the NAND operation performed by the tenth NAND gate 351(32) and outputs a third bit of the third partial product data P3<2>.

An eleventh NAND gate 351(33) performs a NAND operation on a second bit of the fifth weight redundant residue RRNW1_5<1> and the third bit of the fifth vector redundant residue RRNV1_5<2>. An eleventh inverter 352(33) inverts result data of the NAND operation performed by the eleventh NAND gate 351(33) and outputs a second bit of the third partial product data P3<1>.

A twelfth NAND gate 351(34) performs a NAND operation on a first bit of the fifth weight redundant residue RRNW1_5<0> and the third bit of the fifth vector redundant residue RRNV1_5<2>. A twelfth inverter 352(34) inverts result data of the NAND operation performed by the twelfth NAND gate 351(34) and outputs a first bit of the third partial product data P3<0>.

The thirteenth through sixteenth NAND gate-inverter pairs 351P13-351P16, that are arranged in a fourth row of the array, respectively receive bits of the fifth weight redundant residue RRNW1_5<3:0> through first input terminals. The thirteenth through sixteenth NAND gate-inverter pairs 351P13-351P16 commonly receive a fourth bit of the fifth vector redundant residue RRNV1_5<3> through second input terminals.

A thirteenth NAND gate 351(41) performs a NAND operation on a fourth bit of the fifth weight redundant residue RRNW1_5<3> and the fourth bit of the fifth vector redundant residue RRNV1_5<3>. A thirteenth inverter 352(41) inverts result data of the NAND operation performed by the thirteenth NAND gate 351(41) and outputs a fourth bit of a fourth partial product data P4<3>.

A fourteenth NAND gate 351(42) performs a NAND operation on a third bit of the fifth weight redundant residue RRNW1_5<2> and the fourth bit of the fifth vector redundant residue RRNV1_5<3>. A fourteenth inverter 352(42) inverts result data of the NAND operation performed by the fourteenth NAND gate 351(42) and outputs a third bit of the fourth partial product data P4<2>.

A fifteenth NAND gate 351(43) performs a NAND operation on a second bit of the fifth weight redundant residue RRNW1_5<1>and the fourth bit of the fifth vector redundant residue RRNV1_5<3>. A fifteenth inverter 352(43) inverts result data of the NAND operation performed by the fifteenth NAND gate 351(43) and outputs a second bit of the fourth partial product data P4<1>.

A sixteenth NAND gate 351(44) performs a NAND operation on a first bit of the fifth weight redundant residue RRNW1_5<0> and the fourth bit of the fifth vector redundant residue RRNV1_5<3>. A sixteenth inverter 352(44) inverts result data of the NAND operation performed by the sixteenth NAND gate 351(44) and outputs a first bit of the fourth partial product data P4<0>.

Referring back to FIG. 12, first partial product data P1<3:0> and second partial product data P2<3:0> output from the AND array block 350 are respectively transmitted to first and second input terminals of a first adder 361. Third partial product data P3<3:0> and fourth partial product data P4<3:0> output from the AND array block 350 are respectively transmitted to first and second input terminals of a second adder 362.

Although the first partial product data P1<3:0> and the second partial product data P2<3:0> each have a 4-bit size, the first adder 361 performs an addition operation after appending a lower bit “0 ” to the second partial product data P2<3:0>. Accordingly, the first adder 361 has a size capable of performing an addition operation on two 5-bit data, that is, at least 5×3. For example, when the first partial product data P1<3:0> and the second partial product data P2<3:0> are both “1011,” the first adder 361 performs the addition operation of “1011+10110.” As a result, output data of the addition operation from the first adder 361 has a 6-bit size including a carry bit. The first adder 361 outputs first addition data ADD1<5:0> as a result of the addition operation.

Similarly, although the third partial product data P3<3:0> and the fourth partial product data P4<3:0> each have a 4-bit size, the second adder 362 performs an addition operation after appending a lower bit “0 ” to the fourth partial product data P4<3:0>. Accordingly, the second adder 362 has a size capable of performing an addition operation on two 5-bit data, that is, at least 5×3. For example, when the third partial product data P3<3:0> and the fourth partial product data P4<3:0> are both “0000,” the second adder 362 performs the addition operation of “0000+00000.” As a result, output data of the addition operation from the second adder 362 has a 6-bit size including a carry bit. The second adder 362 outputs second addition data ADD2<5:0> as a result of the addition operation.

The third adder 363 receives the first addition data ADD1<5:0> and the second addition data ADD2<5:0> from the first adder 361 and the second adder 362, respectively. Although both the first addition data ADD1<5:0> and the second addition data ADD2<5:0> have a 6-bit size, the third adder 363 performs an addition operation after appending lower bits “00” to the second addition data ADD2<5:0>. Accordingly, the third adder 363 has a size capable of performing an addition operation on two 8-bit data, that is, at least 8×3. For example, when the first addition data ADD1<5:0> is “100001” and the second addition data ADD2<5:0> is “000000,” the third adder 363 performs the addition operation of “100001+00000000.” The third adder 363 outputs, as a result of the addition operation, a fifth multiplication redundant residue RRNWV1_5<7:0> included in the first multiplication redundant residue set.

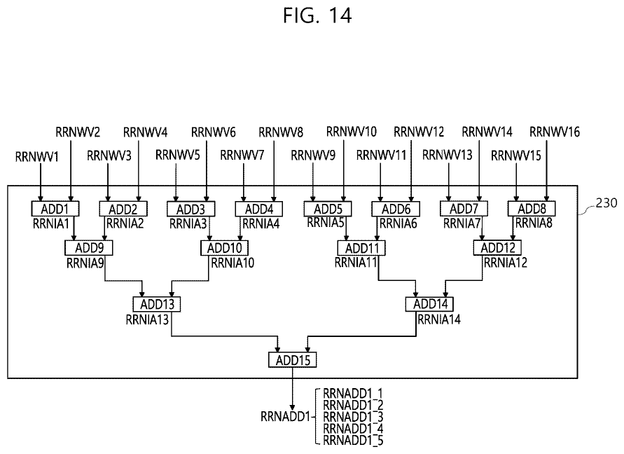

FIG. 14 is a block diagram illustrating an example of an addition circuit included in the processing unit of FIG. 4.

Referring to FIG. 14, an addition circuit 230 receives first through sixteenth multiplication redundant residues RRNWV1-RRNWV16. The addition circuit 230 performs addition operations on the first through sixteenth multiplication redundant residues RRNWV1-RRNWV16. As a result of the addition operations, the addition circuit 230 outputs a first addition redundant residue set RRNADD1. The first addition redundant residue set RRNADD1 includes first through fifth addition redundant residues RRNADD1_1-RRNADD1_5.

The addition circuit 230 includes first through fifteenth adders ADD1-ADD15 arranged in a hierarchical structure such as a tree. The first through fifteenth adders ADD1-ADD15 each have two input terminals and one output terminal. In this case, the first through fifteenth adders ADD1-ADD15 may be distributed across first through fourth stages. The first stage of the addition circuit 230 includes first through eighth adders ADD1-ADD8. The second stage of the addition circuit 230 includes ninth through twelfth adders ADD9-ADD12. The third stage of the addition circuit 230 includes thirteenth and fourteenth adders ADD13 and ADD14. The fourth stage of the addition circuit 230 includes a fifteenth adder ADD15.

In the first-stage, a first adder ADD1 receives first and second multiplication redundant residue sets RRNWV1 and RRNWV2 from the multiplication circuit 220 of FIG. 4. The first adder ADD1 performs an addition operation on the first and second multiplication redundant residue sets RRNWV1 and RRNWV2, and generates and outputs a first intermediate addition redundant residue set RRNIA1. A first-stage second adder ADD2 receives third and fourth multiplication redundant residue sets RRNWV3 and RRNWV4 from the multiplication circuit 220 of FIG. 4. The second adder ADD2 performs an addition operation on the third and fourth multiplication redundant residue sets RRNWV3 and RRNWV4, and generates and outputs a second intermediate addition redundant residue set RRNIA2. Third through eighth adders ADD3-ADD8 of the first stage also generate and output third through eighth intermediate addition redundant residue sets RRNIA3-RRNIA8 in the same manner.

In the second stage, a ninth adder ADD9 receives the first intermediate addition redundant residue set RRNIA1 and the second intermediate addition redundant residue set RRNIA2 from the first adder ADD1 and the second adder ADD2, respectively. The ninth adder ADD9 performs an addition operation on the first intermediate addition redundant residue set RRNIA1 and the second intermediate addition redundant residue set RRNIA2, and generates and outputs a ninth intermediate addition redundant residue set RRNIA9. Similarly, a tenth adder ADD10 generates and outputs a tenth intermediate addition redundant residue set RRNIA10, an eleventh adder ADD11 generates and outputs an eleventh intermediate addition redundant residue set RRNIA11, and a twelfth adder ADD12 generates and outputs a twelfth intermediate addition redundant residue set RRNIA12.

In the third stage, a thirteenth adder ADD13 receives the ninth intermediate addition redundant residue set RRNIA9 and the tenth intermediate addition redundant residue set RRNIA10 from the ninth adder ADD9 and the tenth adder ADD10, respectively. The thirteenth adder ADD13 performs an addition operation on the ninth intermediate addition redundant residue set RRNIA9 and the tenth intermediate addition redundant residue set RRNIA10, and generates and outputs a thirteenth intermediate addition redundant residue set RRNIA13. A fourteenth adder ADD14 receives the eleventh intermediate addition redundant residue set RRNIA11 and the twelfth intermediate addition redundant residue set RRNIA12 from the eleventh adder ADD11 and the twelfth adder ADD12, respectively. The fourteenth adder ADD14 performs an addition operation on the eleventh intermediate addition redundant residue set RRNIA11 and the twelfth intermediate addition redundant residue set RRNIA12, and generates and outputs a fourteenth intermediate addition redundant residue set RRNIA14.

In the fourth stage, a fifteenth adder ADD15 receives the thirteenth intermediate addition redundant residue set RRNIA13 and the fourteenth intermediate addition redundant residue set RRNIA14 from the thirteenth adder ADD13 and the fourteenth adder ADD14, respectively. The fifteenth adder ADD15 performs an addition operation on the thirteenth intermediate addition redundant residue set RRNIA13 and the fourteenth intermediate addition redundant residue set RRNIA14, and generates and outputs a first addition redundant residue set RRNADD1 including first through fifth addition redundant residues RRNADD1_1-RRNADD1_5.

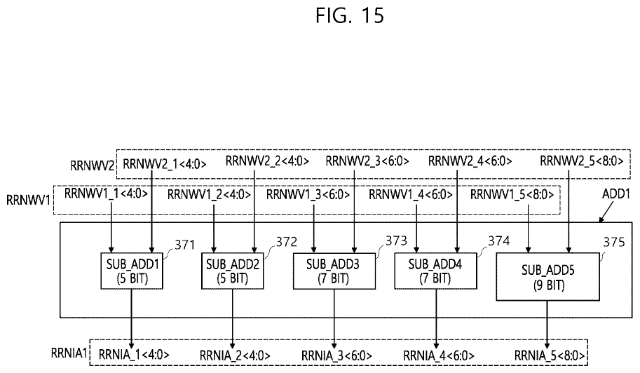

FIG. 15 is a block diagram illustrating an example of a first adder included in the addition circuit of FIG. 14. The description of the first adder in this example may also be applied in the same manner to second through fifteenth adders included in the addition circuit 230 of FIG. 14.

Referring to FIG. 15, the first adder ADD1 includes first through fifth sub-adders 371-375. Each of the first through fifth sub-adders 371-375 may be implemented as a Kogge-Stone adder. In this case, because the first and second sub-adders 371 and 372 perform addition operations on 5-bit input data, they have three stages. The third and fourth sub-adders 373 and 374 perform addition operations on 7-bit input data, and thus have three stages. The fifth sub-adder 375 performs addition operations on 9-bit input data, and thus has four stages.

The first sub-adder 371 receives a first multiplication redundant residue RRNWV1_1<4:0> of a first multiplication redundant residue set RRNWV1 and a first multiplication redundant residue RRNWV2_1<4:0> of a second multiplication redundant residue set RRNWV2. The first sub-adder 371 performs an addition operation on the first multiplication redundant residue RRNWV1_1<4:0> and the first multiplication redundant residue RRNWV2_1<4:0> to output a first intermediate addition redundant residue RRNIA1_1<4:0> of a first intermediate addition redundant residue set RRNIA1.

The second sub-adder 372 receives a second multiplication redundant residue RRNWV1_2<4:0> of the first multiplication redundant residue set RRNWV1 and a second multiplication redundant residue RRNWV2_2<4:0> of the second multiplication redundant residue set RRNWV2. The second sub-adder 372 performs an addition operation on the second multiplication redundant residue RRNWV1_2<4:0> and the second multiplication redundant residue RRNWV2_2<4:0> to output a second intermediate addition redundant residue RRNIA1_2<4:0> of the first intermediate addition redundant residue set RRNIA1.

The third sub-adder 373 receives a third multiplication redundant residue RRNWV1_3<6:0> of the first multiplication redundant residue set RRNWV1 and a third multiplication redundant residue RRNWV2_3<6:0> of the second multiplication redundant residue set RRNWV2. The third sub-adder 373 performs an addition operation on the third multiplication redundant residue RRNWV1_3<6:0> and the third multiplication redundant residue RRNWV2_3<6:0> to output a third intermediate addition redundant residue RRNIA1_3<6:0> of the first intermediate addition redundant residue set RRNIA1.

The fourth sub-adder 374 receives a fourth multiplication redundant residue RRNWV1_4<6:0> of the first multiplication redundant residue set RRNWV1 and a fourth multiplication redundant residue RRNWV2_4<6:0> of the second multiplication redundant residue set RRNWV2. The fourth sub-adder 374 performs an addition operation on the fourth multiplication redundant residue RRNWV1_4<6:0> and the fourth multiplication redundant residue RRNWV2_4<6:0> to output a fourth intermediate addition redundant residue RRNIA1_4<6:0> of the first intermediate addition redundant residue set RRNIA1.

The fifth sub-adder 375 receives a fifth multiplication redundant residue RRNWV1_5<8:0> of the first multiplication redundant residue set RRNWV1 and a fifth multiplication redundant residue RRNWV2_5<8:0> of the second multiplication redundant residue set RRNWV2. The fifth sub-adder 375 performs an addition operation on the fifth multiplication redundant residue RRNWV1_5<8:0> and the fifth multiplication redundant residue RRNWV2_5<8:0> to output a fifth intermediate addition redundant residue RRNIA1_5<8:0> of the first intermediate addition redundant residue set RRNIA1.

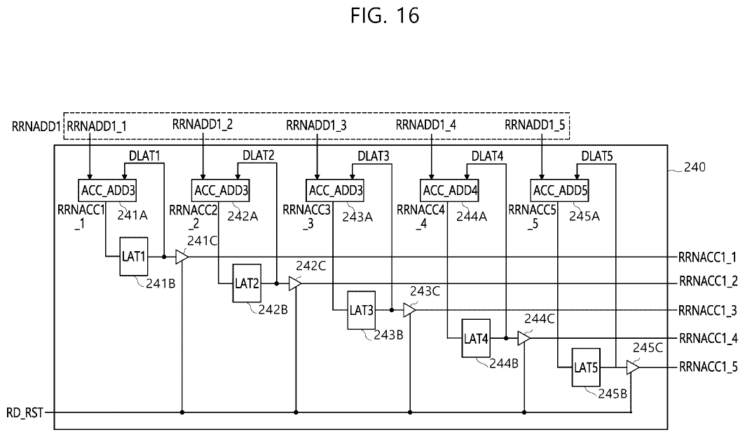

FIG. 16 is a diagram illustrating an example of an accumulation circuit included in the processing unit of FIG. 4.

Referring to FIG. 16, the accumulation circuit 240 includes first through fifth accumulation adders 241A-245A, first through fifth latch circuits 241B-245B, and first through fifth output buffers 241C-245C. Each of the first through fifth accumulation adders 241A-245A has a first input terminal, a second input terminal, and an output terminal. The output terminals of the first through fifth accumulation adders 241A-245A are respectively coupled to the input terminals of the first through fifth latch circuits 241B-245B.

The output terminals of the first through fifth latch circuits 241B-245B are respectively coupled to the second input terminals of the first through fifth accumulation adders 241A-245A, and are also respectively coupled to the input terminals of the first through fifth output buffers 241C-245C. The output terminals of the first through fifth output buffers 241C-245C are respectively coupled to the first through fifth output lines of the accumulation circuit 240.

The first accumulation adder 241A receives the first addition redundant residue RRNADD1_1 of the first addition redundant residue set RRNADD1 output from the addition circuit 230 of FIG. 4. The first accumulation adder 241A also receives first latch data DLAT1 from the first latch circuit 241B. The first latch data DLAT1 is data latched in the first latch circuit 241B as a result of a previous accumulation operation of the accumulation circuit 240. The first accumulation adder 241A performs an accumulated addition operation on the first addition redundant residue RRNADD1_1 of the first addition redundant residue set RRNADD1 and the first latch data DLAT1 to output a first accumulated redundant residue RRNACC1_1. The first latch circuit 241B receives and latches the first accumulated redundant residue RRNACC1_1 output from the first accumulation adder 241A.

The second accumulation adder 242A receives the second addition redundant residue RRNADD1_2 of the first addition redundant residue set RRNADD1 output from the addition circuit 230 of FIG. 4. The second accumulation adder 242A also receives second latch data DLAT2 from the second latch circuit 242B. The second latch data DLAT2 is data latched in the second latch circuit 242B as a result of a previous accumulation operation of the accumulation circuit 240. The second accumulation adder 242A performs an accumulated addition operation on the second addition redundant residue RRNADD1_2 of the first addition redundant residue set RRNADD1 and the second latch data DLAT2 to output a second accumulated redundant residue RRNACC1_2. The second latch circuit 242B receives and latches the second accumulated redundant residue RRNACC1_2 output from the second accumulation adder 242A.

The third accumulation adder 243A receives the third addition redundant residue RRNADD1_3 of the first addition redundant residue set RRNADD1 output from the addition circuit 230 of FIG. 4. The third accumulation adder 243A also receives third latch data DLAT3 from the third latch circuit 243B. The third latch data DLAT3 is data latched in the third latch circuit 243B as a result of a previous accumulation operation of the accumulation circuit 240. The third accumulation adder 243A performs an accumulated addition operation on the third addition redundant residue RRNADD1_3 of the first addition redundant residue set RRNADD1 and the third latch data DLAT3 to output a third accumulated redundant residue RRNACC1_3. The third latch circuit 243B receives and latches the third accumulated redundant residue RRNACC1_3 output from the third accumulation adder 243A.

The fourth accumulation adder 244A receives the fourth addition redundant residue RRNADD1_4 of the first addition redundant residue set RRNADD1 output from the addition circuit 230 of FIG. 4. The fourth accumulation adder 244A also receives fourth latch data DLAT4 from the fourth latch circuit 244B. The fourth latch data DLAT4 is data latched in the fourth latch circuit 244B as a result of a previous accumulation operation of the accumulation circuit 240. The fourth accumulation adder 244A performs an accumulated addition operation on the fourth addition redundant residue RRNADD1_4 of the first addition redundant residue set RRNADD1 and the fourth latch data DLAT4 to output a fourth accumulated redundant residue RRNACC1_4. The fourth latch circuit 244B receives and latches the fourth accumulated redundant residue RRNACC1_4 output from the fourth accumulation adder 244A.

The fifth accumulation adder 245A receives the fifth addition redundant residue RRNADD1_5 of the first addition redundant residue set RRNADD1 output from the addition circuit 230 of FIG. 4. The fifth accumulation adder 245A also receives fifth latch data DLAT5 from the fifth latch circuit 245B. The fifth latch data DLAT5 is data latched in the fifth latch circuit 245B as a result of a previous accumulation operation of the accumulation circuit 240. The fifth accumulation adder 245A performs an accumulated addition operation on the fifth addition redundant residue RRNADD1_5 of the first addition redundant residue set RRNADD1 and the fifth latch data DLAT5 to output a fifth accumulated redundant residue RRNACC1_5. The fifth latch circuit 245B receives and latches the fifth accumulated redundant residue RRNACC1_5 output from the fifth accumulation adder 245A.

The first latch circuit 241B transfers the first accumulated redundant residue RRNACC1_1 to the input terminal of the first output buffer 241C, and also feeds it back to the first accumulation adder 241A. The first accumulated redundant residue RRNACC1_1 fed back to the first accumulation adder 241A may be used as first latch data DLAT1 in a subsequent accumulation operation of the accumulation circuit 240. The first output buffer 241C, depending on a first logic level of the result read signal RD_RST, may output the first accumulated redundant residue RRNACC1_1 transferred from the first latch circuit 241B. When the result read signal RD_RST is at a second logic level, the first output buffer 241C does not output the first accumulated redundant residue RRNACC1_1.

The second latch circuit 242B transfers the second accumulated redundant residue RRNACC1_2 to the input terminal of the second output buffer 242C, and also feeds it back to the second accumulation adder 242A. The second accumulated redundant residue RRNACC1_2 fed back to the second accumulation adder 242A may be used as second latch data DLAT2 in a subsequent accumulation operation of the accumulation circuit 240. The second output buffer 242C, depending on a first logic level of the result read signal RD_RST, may output the second accumulated redundant residue RRNACC1_2 transferred from the second latch circuit 242B. When the result read signal RD_RST is at a second logic level, the second output buffer 242C does not output the second accumulated redundant residue RRNACC1_2.

The third latch circuit 243B transfers the third accumulated redundant residue RRNACC1_3 to the input terminal of the third output buffer 243C, and also feeds it back to the third accumulation adder 243A. The third accumulated redundant residue RRNACC1_3 fed back to the third accumulation adder 243A may be used as third latch data DLAT3 in a subsequent accumulation operation of the accumulation circuit 240. The third output buffer 243C, depending on a first logic level of the result read signal RD_RST, may output the third accumulated redundant residue RRNACC1_3 transferred from the third latch circuit 243B. When the result read signal RD_RST is at a second logic level, the third output buffer 243C does not output the third accumulated redundant residue RRNACC1_3.

The fourth latch circuit 244B transfers the fourth accumulated redundant residue RRNACC1_4 to the input terminal of the fourth output buffer 244C, and also feeds it back to the fourth accumulation adder 244A. The fourth accumulated redundant residue RRNACC1_4 fed back to the fourth accumulation adder 244A may be used as fourth latch data DLAT4 in a subsequent accumulation operation of the accumulation circuit 240. The fourth output buffer 244C, depending on a first logic level of the result read signal RD_RST, may output the fourth accumulated redundant residue RRNACC1_4 transferred from the fourth latch circuit 244B. When the result read signal RD_RST is at a second logic level, the fourth output buffer 244C does not output the fourth accumulated redundant residue RRNACC1_4.

The fifth latch circuit 245B transfers the fifth accumulated redundant residue RRNACC1_5 to the input terminal of the fifth output buffer 245C, and also feeds it back to the fifth accumulation adder 245A. The fifth accumulated redundant residue RRNACC1_5 fed back to the fifth accumulation adder 245A may be used as fifth latch data DLAT5 in a subsequent accumulation operation of the accumulation circuit 240. The fifth output buffer 245C, depending on a first logic level of the result read signal RD_RST, may output the fifth accumulated redundant residue RRNACC1_5 transferred from the fifth latch circuit 245B. When the result read signal RD_RST is at a second logic level, the fifth output buffer 245C does not output the fifth accumulated redundant residue RRNACC1_5.

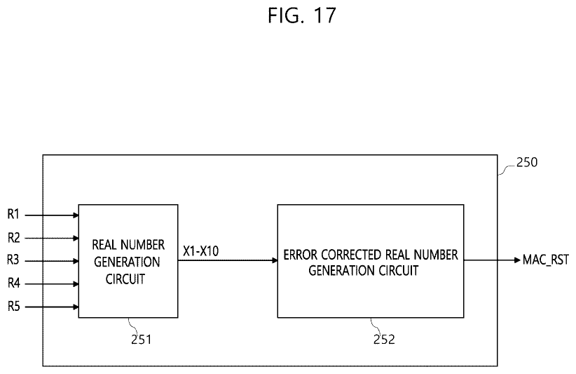

FIG. 17 is a block diagram illustrating an example of a reconstruction circuit included in the processing unit of FIG. 4.

Referring to FIG. 17, reconstruction circuit 250 receives a first accumulated redundant residue set RRNACC1 including first through fifth accumulated redundant residues RRNACC1_1-RRNACC1_5 from accumulation circuit 240 of FIG. 4. Reconstruction circuit 250 performs reconstruction by using first through fifth moduli m1-m5 employed in redundant residue number generation circuit 210 together with the first through fifth accumulated redundant residues RRNACC1_1-RRNACC1_5, and generates and outputs result data MAC_RST in a weighted number system. Reconstruction circuit 250 is configured to correct errors that may occur during the MAC operation performed in processing unit 200 of FIG. 4 while generating the result data MAC_RST.

Reconstruction circuit 250 may include real number generation circuit 251 and error corrected real number generation circuit 252. Real number generation circuit 251 receives first through fifth redundant residues R1-R5 from accumulation circuit 240 of FIG. 4. In this embodiment, the first through fifth redundant residues R1-R5 represent the first through fifth accumulated redundant residues included in the accumulated redundant residue set output from accumulation circuit 240 of processing unit 200 of FIG. 4. For example, as described with reference to FIG. 16, the first through fifth accumulated redundant residues RRNACC1_1-RRNACC1_5 output from accumulation circuit 240 may be provided to real number generation circuit 251 as the first through fifth redundant residues R1-R5. Inside real number generation circuit 251, first through fifth moduli m1-m5 are set. In an embodiment, real number generation circuit 251 may receive first through fifth moduli m1-m5 from an external source.

Real number generation circuit 251 may generate a real number X by using three moduli selected from among the first through fifth moduli m1-m5 and three accumulated redundant residues corresponding the selected three moduli. Because the total number of moduli is five, and five accumulated redundant residues respectively correspond to the five moduli, the number of possible combinations of selecting three moduli and three accumulated redundant residues in real number generation circuit 251 is 5C3, that is, ten. Real number generation circuit 251 may generate first through tenth real numbers X1-X10 corresponding to all possible ten cases. In one embodiment, real number generation circuit 251 may apply the Chinese Remainder Theorem (CRT) to generate the first through tenth real numbers X1-X10. In an embodiment, real number generation circuit 251 may apply Mixed Radix Conversion (MRC) to generate the first through tenth real numbers X1-X10.

Error corrected real number generation circuit 252 receives the first through tenth real numbers X1-X10 generated by real number generation circuit 251. Error corrected real number generation circuit 252 restores the first through fifth redundant residues R1-R5 of the RRNS system into result data MAC_RST in the weighted number system, by performing filtering, comparison, error correction, and real number determination operations on the first through tenth real numbers X1-X10.

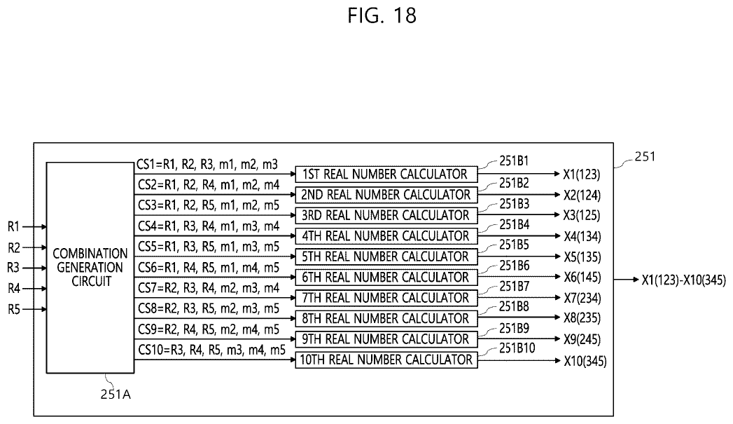

FIG. 18 is a block diagram illustrating an example of a real number generation circuit included in the reconstruction circuit of FIG. 17.

Referring to FIG. 18, real number generation circuit 251 includes a combination generation circuit 251A and first through tenth real number calculators 251B1-251B10. Combination generation circuit 251A generates and outputs first through tenth combination sets CS1-CS10 based on the first through fifth redundant residues R1-R5 and the first through fifth moduli m1-m5. Each of the first through tenth combination sets CS1-CS10 includes three redundant residues selected from the first through fifth redundant residues R1-R5 such that no overlap occurs, and three moduli corresponding to the selected redundant residues. Combination generation circuit 251A may transmit the first through tenth combination sets CS1-CS10 respectively to the first through tenth real number calculators 251B1-251B10.

The first combination set CS1 includes the first, second, and third redundant residues R1, R2, and R3 and the first, second, and third moduli m1, m2, and m3. The second combination set CS2 includes the first, second, and fourth redundant residues R1, R2, and R4 and the first, second, and fourth moduli m1, m2, and m4. The third combination set CS3 includes the first, second, and fifth redundant residues R1, R2, and R5 and the first, second, and fifth moduli m1, m2, and m5. The fourth combination set CS4 includes the first, third, and fourth redundant residues R1, R3, and R4 and the first, third, and fourth moduli m1, m3, and m4. The fifth combination set CS5 includes the first, third, and fifth redundant residues R1, R3, and R5 and the first, third, and fifth moduli m1, m3, and m5.

The sixth combination set CS6 includes the first, fourth, and fifth redundant residues R1, R4, and R5 and the first, fourth, and fifth moduli m1, m4, and m5. The seventh combination set CS7 includes the second, third, and fourth redundant residues R2, R3, and R4 and the second, third, and fourth moduli m2, m3, and m4. The eighth combination set CS8 includes the second, third, and fifth redundant residues R2, R3, and R5 and the second, third, and fifth moduli m2, m3, and m5. The ninth combination set CS9 includes the second, fourth, and fifth redundant residues R2, R4, and R5 and the second, fourth, and fifth moduli m2, m4, and m5. The tenth combination set CS10 includes the third, fourth, and fifth redundant residues R3, R4, and R5 and the third, fourth, and fifth moduli m3, m4, and m5.

The first through tenth real number calculators 251B1-251B10 generate and output first through tenth real numbers X1(123)-X10(345) by using the first through tenth combination sets CS1-CS10 respectively transmitted from combination generation circuit 251A. Specifically, first real number calculator 251B1 generates and outputs first real number X1(123) by using first combination set CS1, that is, the first, second, and third redundant residues R1, R2, and R3, and the first, second, and third moduli m1, m2, and m3. Second real number calculator 251B2 generates and outputs second real number X2(124) by using second combination set CS2, that is, the first, second, and fourth redundant residues R1, R2, and R4, and the first, second, and fourth moduli m1, m2, and m4. Third real number calculator 251B3 generates and outputs third real number X3(125) by using third combination set CS3, that is, the first, second, and fifth redundant residues R1, R2, and R5, and the first, second, and fifth moduli m1, m2, and m5.

Fourth real number calculator 251B4 generates and outputs fourth real number X4(134) by using fourth combination set CS4, that is, the first, third, and fourth redundant residues R1, R3, and R4, and the first, third, and fourth moduli m1, m3, and m4. Fifth real number calculator 251B5 generates and outputs fifth real number X5(135) by using fifth combination set CS5, that is, the first, third, and fifth redundant residues R1, R3, and R5, and the first, third, and fifth moduli m1, m3, and m5. Sixth real number calculator 251B6 generates and outputs sixth real number X6(145) by using sixth combination set CS6, that is, the first, fourth, and fifth redundant residues R1, R4, and R5, and the first, fourth, and fifth moduli m1, m4, and m5.

Seventh real number calculator 251B7 generates and outputs seventh real number X7(234) by using seventh combination set CS7, that is, the second, third, and fourth redundant residues R2, R3, and R4, and the second, third, and fourth moduli m2, m3, and m4. Eighth real number calculator 251B8 generates and outputs eighth real number X8(235) by using eighth combination set CS8, that is, the second, third, and fifth redundant residues R2, R3, and R5, and the second, third, and fifth moduli m2, m3, and m5. Ninth real number calculator 251B9 generates and outputs ninth real number X9(245) by using ninth combination set CS9, that is, the second, fourth, and fifth redundant residues R2, R4, and R5, and the second, fourth, and fifth moduli m2, m4, and m5. Tenth real number calculator 251B10 generates and outputs tenth real number X10(345) by using tenth combination set CS10, that is, the third, fourth, and fifth redundant residues R3, R4, and R5, and the third, fourth, and fifth moduli m3, m4, and m5.

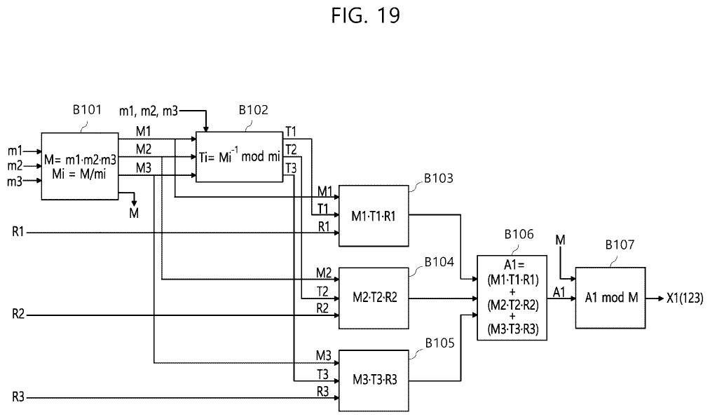

FIG. 19 is a diagram illustrating an example of an operation process in a first real number calculator of FIG. 18.

Referring to FIG. 19, first real number calculator 251B1 of FIG. 18 receives first combination set CS1, that is, first, second, and third redundant residues R1, R2, and R3, and first, second, and third moduli m1, m2, and m3. In this example, first real number calculator 251B1 generates first real number X1 by applying the Chinese Remainder Theorem (CRT). The generation of first real number X1 in first real number calculator 251B1 using CRT may be performed through operations in first through seventh operation blocks B101-B107.

First operation block B101 receives first, second, and third moduli m1, m2, and m3. First operation block B101 performs multiplication of the first, second, and third moduli m1, m2, and m3, that is, the operation “m1·m2·m3,” and generates modulus product M. Next, first operation block B101 generates partial moduli Mi for the first, second, and third moduli m1, m2, and m3 by using modulus product M. First partial modulus M1 is generated by performing operation “M/m1.” Second partial modulus M2 is generated by performing operation “M/m2.” Third partial modulus M3 is generated by performing operation “M/m3.”

Second operation block B102 receives first, second, and third moduli m1, m2, and m3, and also receives first, second, and third partial moduli M1, M2, and M3 from first operation block B101. Second operation block B102 generates modular inverses Ti for first, second, and third partial moduli M1, M2, and M3. First modular inverse T1 is generated by performing modular operation “M1⁻¹ mod m1.” Second modular inverse T2 is generated by performing modular operation “M2⁻¹ mod m2.” Third modular inverse T3 is generated by performing modular operation “M3⁻¹ mod m3.”

The third operation block B103, fourth operation block B104, and fifth operation block B105 perform multiplication operations in parallel on partial moduli, modular inverses, and redundant residues. Specifically, third operation block B103 receives first partial modulus M1 and first modular inverse T1 from first operation block B101 and second operation block B102, respectively. In addition, third operation block B103 receives first redundant residue R1. Third operation block B103 performs a multiplication operation on first partial modulus M1, first modular inverse T1, and first redundant residue R1, that is, the operation “M1·T1·R1.”

Fourth operation block B104 receives second partial modulus M2 and second modular inverse T2 from first operation block B101 and second operation block B102, respectively. In addition, fourth operation block B104 receives second redundant residue R2. Fourth operation block B104 performs a multiplication operation on second partial modulus M2, second modular inverse T2, and second redundant residue R2, that is, the operation “M2·T2·R2.”

Fifth operation block B105 receives third partial modulus M3 and third modular inverse T3 from first operation block B101 and second operation block B102, respectively. In addition, fifth operation block B105 receives third redundant residue R3. Fifth operation block B105 performs a multiplication operation on third partial modulus M3, third modular inverse T3, and third redundant residue R3, that is, the operation “M3·T3·R3.”

The sixth operation block B106 generates a first dividend A1, that is used in the modular operation for calculating the first real number X1. The first dividend A1 is calculated by an addition operation of the values obtained from the third operation block B103, the fourth operation block B104, and the fifth operation block B105, namely the operation “M1·T1·R1+M2·T2·R2+M3·T3·R3.”

The seventh operation block B107 performs a modular operation using the first dividend A1 generated by the sixth operation block B106 and the first modulus product M, and generates the first real number X1(123). The first real number X1(123) may be generated through the modular operation “A1 mod M.”

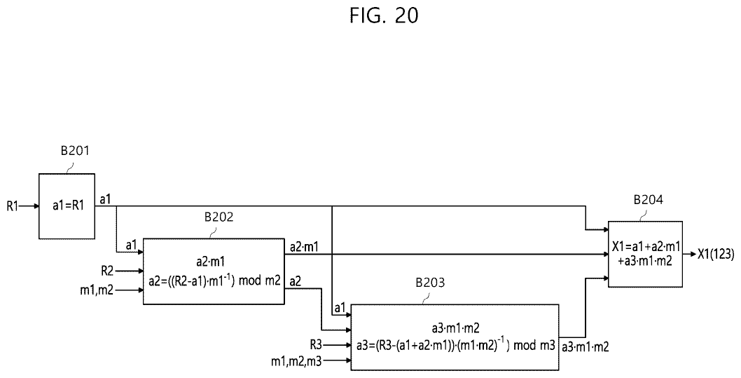

FIG. 20 is a diagram illustrating another example of an operation process in the first real number calculator of FIG. 18. The following description may also be identically applied to the second through the tenth real number calculators of FIG. 18.

Referring to FIG. 20, the first real number calculator (25B1 of FIG. 18) receives the first combination set (CS1), namely the first, second, and third redundant residues (R1, R2, R3) and the first, second, and third moduli (m1, m2, m3). In this example, the first real number calculator (251B1 of FIG. 18) generates the first real number (X1) by using MRC. The generation of the first real number (X1) in the first real number calculator (251B1 of FIG. 18) by using MRC may be performed through the operations of the first to fourth operation blocks (B201-B204). The first real number (X1(123)) generated by using MRC may be reconstructed through the operation “X=a1+a2·m1+a3·m1·m2.” Here, a1, a2, and a3 are mixed-radix digits.

The first operation block B201 receives the first redundant residue R1 and generates and outputs the first mixed-radix digit a1, that corresponds to the zeroth term in a mixed-radix representation. The first mixed-radix digit a1 is identical to the first redundant residue R1.

The second operation block B202 receives the first mixed-radix digit a1 output from the first operation block B201. In addition, the second operation block B202 receives the first and second moduli m1 and m2, and the second redundant residue R2. The second operation block B202 generates and outputs the second mixed-radix digit a2 through the operation “((R2-a1)·m1⁻¹) mod m2.” The second operation block B202 also generates and outputs the first positional term a2·m1 in the mixed-radix representation through a multiplication operation of the second mixed-radix digit a2 and the first modulus m1.

The third operation block B203 receives the first mixed-radix digit a1 and the second mixed-radix digit a2 respectively from the first operation block B201 and the second operation block B202. In addition, the third operation block B203 receives the first, second, and third moduli m1, m2, and m3, and the third redundant residue R3. The third operation block B203 generates and outputs the third mixed-radix digit a3 through the operation “(R3-(a1+a2·m1))·(m1·m2)⁻¹ mod m3.” The third operation block B203 also generates and outputs the second positional term a3·m1·m2 in the mixed-radix representation through multiplication operations of the third mixed-radix digit a3, the first modulus m1, and the second modulus m2.

The fourth operation block B204 receives the zeroth term a1, the first positional term a2·m1, and the second positional term a3·m1·m2, respectively, from the first operation block B201, the second operation block B202, and the third operation block B203. The fourth operation block B204 performs the addition operation “a1+a2·m1+a3·m1·m2” by summing the zeroth term a1, the first positional term a2·m1, and the second positional term a3·m1·m2, and generates and outputs the first real number X1(123).

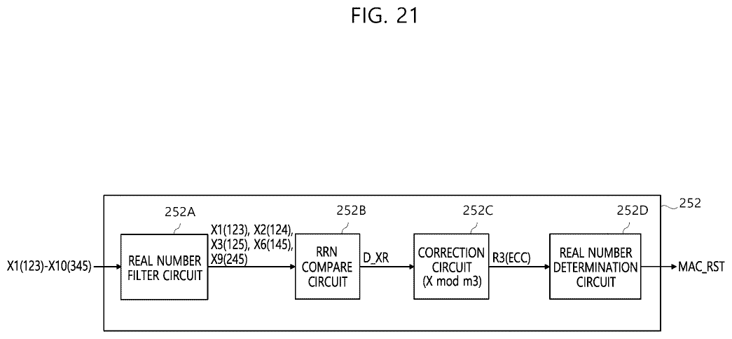

FIG. 21 is a block diagram illustrating an example of an error-corrected real number generation circuit included in the reconstruction circuit of FIG. 17 according to an embodiment of the present disclosure.

Referring to FIG. 21, the error corrected real number generation circuit 252 determines whether an error has occurred in the computation process of the processing unit (FIGS. 4, 200) by using the first through tenth real numbers X1(123)-X10(345) output from the real number generation circuit (FIGS. 17, 251). When an error occurs, the error corrected real number generation circuit 252 performs error correction and outputs error-corrected MAC result data. The error corrected real number generation circuit 252 includes a real number filter circuit 252A, an RRN compare circuit 252B, a correction circuit 252C, and a real number determination circuit 252D.

The real number filter circuit 252A receives the first through tenth real numbers X1(123)-X10(345) generated by the real number generation circuit (FIGS. 17, 251) of the reconstruction circuit 250. The real number filter circuit 252A performs filtering on the first through tenth real numbers X1(123)-X10(345). The real number filter circuit 252A outputs only those real numbers that satisfy the filtering condition. In one embodiment, filtering in the real number filter circuit 252A may be performed by selecting real numbers whose values are less than or equal to the product of the information moduli, i.e., the first, second, and third moduli m1, m2, and m3.

For example, assume that the first through tenth real numbers X1(123)-X10(345) are 33, 21, 21, 63, 153, 21, 133, 153, 21, and 98, respectively, and the first, second, and third moduli m1, m2, and m3 are 3, 4, and 5, respectively. In this case, because the product of the first, second, and third moduli m1, m2, and m3 is 3×4×5=60, the fourth, fifth, seventh, eighth, and tenth real numbers having values of 63, 153, 133, 153, and 98 (i.e., X4(134), X5(135), X7(234), X8(235), and X10(345)) are filtered out. Accordingly, the real number filter circuit 252A outputs only the first, second, third, sixth, and ninth real numbers X1(123), X2(124), X3(125), X6(145), and X9(245), that are not filtered.

The RRN compare circuit 252B receives selected real numbers, for example, the first, second, third, sixth, and ninth real numbers X1(123), X2(124), X3(125), X6(145), and X9(245), from the real number filter circuit 252A. The RRN compare circuit 252B performs a first comparison operation on the first, second, third, sixth, and ninth real numbers X1(123), X2(124), X3(125), X6(145), and X9(245). In addition, the RRN compare circuit 252B performs a second comparison operation on the redundant residues used to generate the first, second, third, sixth, and ninth real numbers X1(123), X2(124), X3(125), X6(145), and X9(245).

Specifically, the RRN compare circuit 252B first compares the first, second, third, sixth, and ninth real numbers X1(123), X2(124), X3(125), X6(145), and X9(245) to detect a real number having a value different from the majority of real numbers having the same value. Next, the RRN compare circuit 252B compares the redundant residues used to generate the real number having the different value with the redundant residues used to generate the real numbers having the same value. The RRN compare circuit 252B outputs comparison result data D_XR including information about the common value of the majority of the real numbers and the redundant residue that is not used to generate the real numbers having the common value but is used only to generate the real number having the different value.

For example, in the case where the first, second, third, sixth, and ninth real numbers X1(123), X2(124), X3(125), X6(145), and X9(245) have values of 33, 21, 21, 21, and 21, respectively, the second, third, sixth, and ninth real numbers X2(124), X3(125), X6(145), and X9(245) all have the same value 21, while the first real number X1(123) has a different value 33. The redundant residues used to generate the first real number X1(123) are the first, second, and third redundant residues R1, R2, and R3. The redundant residues used to generate the second real number X2(124) are the first, second, and fourth redundant residues R1, R2, and R4. The redundant residues used to generate the third real number X3(125) are the first, second, and fifth redundant residues R1, R2, and R5. The redundant residues used to generate the sixth real number X6(145) are the first, fourth, and fifth redundant residues R1, R4, and R5. The redundant residues used to generate the ninth real number X9(245) are the second, fourth, and fifth redundant residues R2, R4, and R5. In this case, the redundant residue that is not used to generate the second, third, sixth, and ninth real numbers X2(124), X3(125), X6(145), and X9(245) having the common value 21 but is used only to generate the first real number X1(123) having the different value 33 is the third redundant residue R3. Accordingly, the RRN compare circuit 252B outputs the comparison result data D_XR including the common value 21 of the second, third, sixth, and ninth real numbers X2(124), X3(125), X6(145), and X9(245), and the information about the third redundant residue R3, that is used only to generate the first real number X1(123) having the different value 33.

The correction circuit 252C receives the comparison result data D_XR output from the RRN compare circuit 252B. The correction circuit 252C calculates and outputs an error-corrected redundant residue using the real number and redundant residue included in the comparison result data D_XR. When the comparison result data D_XR includes a real number X and an i-th redundant residue Ri, the correction circuit 252C performs a modular operation “Ri(ECC)=X mod mi,” where i is one of natural numbers from 1 to 5, to output the error-corrected i-th redundant residue Ri(ECC).

In the above example, because the comparison result data D_XR includes the real number 21 and the third redundant residue R3, the correction circuit 252C performs a modular operation “R3(ECC)=21 mod 5” to output the error-corrected third redundant residue R3(ECC), in which the erroneous value 3 is corrected to 1.

The real number determination circuit 252D recalculates the real number based on the error-corrected redundant residue output from the correction circuit 252C, and generates and outputs error-corrected MAC result data MAC_RST. In the above example, because the third redundant residue R3 having the value 3 is corrected to the error-corrected third redundant residue R3(ECC) having the value 1, the real number determination circuit 252D performs the real number reconstruction process using the error-corrected third redundant residue R3(ECC).

The real number reconstruction process in the real number determination circuit 252D may be performed using CRT (Chinese Remainder Theorem), as described with reference to FIG. 19. When CRT is applied, the real number reconstruction process in the real number determination circuit 252D may be performed by the operation “X(123)=(M1·T1·R1+M2·T2·R2+M3·T3·R3 (ECC)) mod M.” For example, when the first, second, and third moduli m1, m2, and m3 are 3, 4, and 5, respectively, and the first, second, and third redundant residues R1, R2, and R3(ECC) are 0, 1, and 1, respectively, the modulus product M is “m1×m2×m3=3×4 ×5=60,” “M1·T1·R1=20×2×0=0,” “M2·T2·R2=15×3×1=45,” and “M3·T3·R3(ECC)=12×3×1=36.” Therefore, the reconstructed real number X(123) becomes the corrected normal value “(0+45+36) mod 60=21.” Alternatively, the real number reconstruction process in the real number determination circuit 252D may also be performed using MRC (Mixed Radix Conversion), as described with reference to FIG. 20.

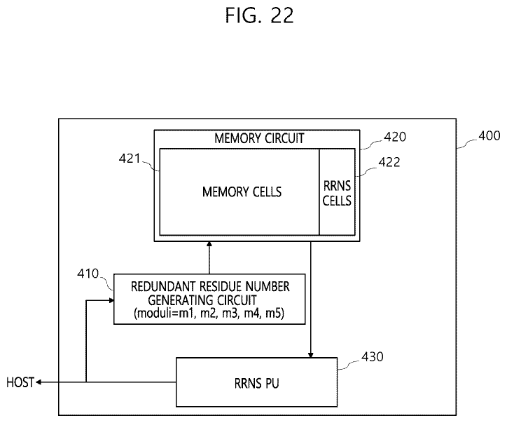

FIG. 22 is a block diagram illustrating another example of a PIM device according to an embodiment of the present disclosure.

Referring to FIG. 22, the PIM device 400 includes a redundant residue number generation circuit 410, a memory circuit 420, and a processing unit 430. The redundant residue number generation circuit 410 receives write data transmitted from a host. The write data may be data having a sign in an 8-bit integer format. The redundant residue number generation circuit 410 performs modular operations on unsigned write data, excluding the sign bit, using first to fifth moduli m1-m5, and generates first to fifth redundant residues based on RRNS, and outputs them together with the sign bit.

The memory circuit 420 may include memory cells 421 and RRNS cells 422. The memory cells 421 and the RRNS cells 422 may have a cell array structure. The memory circuit 420 may perform a memory write operation and an operation read operation. Through the memory write operation, the memory circuit 420 stores the sign bit and the first to fifth redundant residues transmitted from the redundant residue number generation circuit 410 as write data.

In one embodiment, the memory circuit 420 stores the sign bit and a first portion of the first to fifth redundant residues in the memory cells 421, and stores a second portion of the first to fifth redundant residues in the RRNS cells 422. Through the operation read operation, the memory circuit 420 provides the sign bit and the first to fifth redundant residues stored in the memory circuit 420 to the processing unit 430 as operands.

The processing unit 430 may receive a weight sign bit and first to fifth weight redundant residues from the memory circuit 420. The processing unit 430 may also receive a vector sign bit and first to fifth vector redundant residues from the memory circuit 420. The processing unit 430 may perform a multiply-and-accumulate (MAC) operation using the weight sign bit and the first to fifth weight redundant residues together with the vector sign bit and the first to fifth vector redundant residues, and generate first to fifth accumulated redundant residues.

The processing unit 430 may convert the first to fifth accumulated redundant residues, that are based on RRNS, into MAC result data based on a weighted number system, and output the result data to the host. The processing unit 430 may be configured to correct errors occurring during the MAC operation by using the first to fifth moduli and the first to fifth accumulated redundant residues.

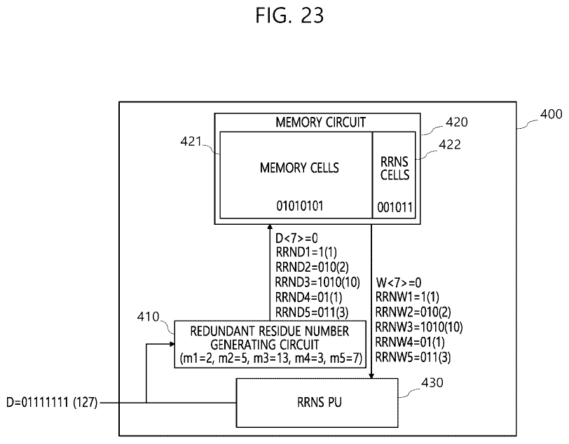

FIG. 23 is a diagram illustrating a data processing procedure based on RRNS performed in the PIM device of FIG. 22 according to an embodiment of the present disclosure.

Referring to FIG. 23, an example is illustrated in which signed 8-bit integer (INT8) data D=01111111 (decimal 127) is transmitted from the host to the processing unit 400. The data D=01111111 is input to the redundant residue number generation circuit 410 of the processing unit 400. The redundant residue number generation circuit 410 outputs the most significant bit (MSB) of the data D, i.e., 0, as the sign bit D<7>. The redundant residue number generation circuit 410 performs first to fifth modular operations using the first to fifth moduli m1-m5 with respect to the unsigned data 1111111. In this example, it is assumed that the first modulus m1, the second modulus m2, and the third modulus m3, that are information moduli, are 2, 5, and 13, respectively, and that the fourth modulus m4 and the fifth modulus m5, that are redundant moduli, are 3 and 7, respectively.

Specifically, the redundant residue number generation circuit 410 performs a first modular operation in which the unsigned data D=1111111 is divided by the first modulus m1=2, i.e., “1111111 mod 2”. The redundant residue number generation circuit 410 outputs the result of the first modular operation, i.e., 1 (decimal 1), as the first redundant residue RRND1.

The redundant residue number generation circuit 410 performs a second modular operation in which the unsigned data D=1111111 is divided by the second modulus m2=5, i.e., “1111111 mod 5”. The redundant residue number generation circuit 410 outputs the result of the second modular operation, i.e., 010 (decimal 2), as the second redundant residue RRND2.

The redundant residue number generation circuit 410 performs a third modular operation in which the unsigned data D=1111111 is divided by the third modulus m3=13, i.e., “1111111 mod 13”. The redundant residue number generation circuit 410 outputs the result of the third modular operation, i.e., 1010 (decimal 10), as the third redundant residue RRND3.

The redundant residue number generation circuit 410 performs a fourth modular operation in which the unsigned data D=1111111 is divided by the fourth modulus m4=3, i.e., “1111111 mod 3”. The redundant residue number generation circuit 410 outputs the result of the fourth modular operation, i.e., 01 (decimal 1), as the fourth redundant residue RRND4.

The redundant residue number generation circuit 410 performs a fifth modular operation in which the unsigned data D=1111111 is divided by the fifth modulus m5=7, i.e., “1111111 mod 7”. The redundant residue number generation circuit 410 outputs the result of the fifth modular operation, i.e., 011 (decimal 3), as the fifth redundant residue RRND5.

The redundant residue number generation circuit 410 transfers the sign bit D<7>=0, the first redundant residue RRND1=1, the second redundant residue RRND2=010, the third redundant residue RRND3=1010, the fourth redundant residue RRND4=01, and the fifth redundant residue RRND5=011 to the memory circuit 420. In this example, the first redundant residue RRND1 has a size of 1 bit, the second redundant residue RRND2 and the fifth redundant residue RRND5 each have a size of 3 bits, the third redundant residue RRND3 has a size of 4 bits, and the fourth redundant residue RRND4 has a size of 2 bits. Accordingly, the sign bit D<7> together with the first through fifth redundant residues RRND1-RRND5 collectively amount to 14 bits in total.

The memory circuit 420 may store a first portion of the sign bit D<7> and the first through fifth redundant residues RRND1-RRND5 in memory cells 421, and may store a second portion of the first through fifth redundant residues RRND1-RRND5 in RRNS cells 422. In one embodiment, the first portion of the first through fifth redundant residues RRND1-RRND5 may correspond to seven bits, that are obtained by excluding the sign bit D<7> from the total eight bits of the data D. The second portion may correspond to six bits, that are the remaining lower bits excluding the seven-bit first portion. Accordingly, the memory cells 421 may store “01010101,” and the RRNS cells 422 may store “001011.”

In this example, the sign bit D<7> having a value of 0, the first redundant residue RRND1 having a value of 1, and the second redundant residue RRND2 having a value of 010 are stored in the memory cells 421. Among the four-bit third redundant residue RRND3 having a value of 1010, the upper three bits “101” are stored in the memory cells 421, while the lower one bit “0” is stored in the RRNS cells 422. The fourth redundant residue RRND4 having a value of 01 and the fifth redundant residue RRND5 having a value of 011 are stored in the RRNS cells 422. The six-bit data “001011” stored in the RRNS cells 422 may be used for error detection and correction, in a manner similar to parity bits generated by the ECC circuit described with reference to FIG. 1.

The memory circuit 420 is configured to provide the sign bit and the first through fifth redundant residues, that are received from the redundant residue number generation circuit 410 and stored in the memory circuit 420, to the processing unit 430. The sign bit and the first through fifth redundant residues may be provided as a weight sign bit W<7> and first through fifth weight redundant residues RRNW1-RRNW5 of weight data, respectively. For example, when the data D=01111111 is transmitted from the host to the PIM device 400, the memory circuit 420 may transfer to the processing unit 430 the weight sign bit W<7> having a value of 0, the first weight redundant residue RRNW1 having a value of 1, the second weight redundant residue RRNW2 having a value of 010, the third weight redundant residue RRNW3 having a value of 1010, the fourth weight redundant residue RRNW4 having a value of 01, and the fifth weight redundant residue RRNW5 having a value of 011. Vector redundant residues, that are used together with the weight redundant residues as operands in the MAC operation performed in the processing unit 430, may also be provided from the memory circuit 420 to the processing unit 430 in the same manner.

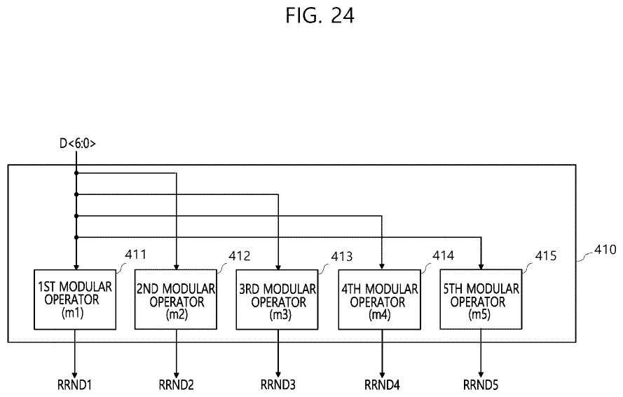

FIG. 24 is a block diagram illustrating an example of a redundant residue number generation circuit included in the PIM device of FIG. 22 according to an embodiment of the present disclosure.

Referring to FIG. 24, the redundant residue number generation circuit 410 may include first through fifth modular operators 411-415 corresponding to first through fifth moduli m1-m5, respectively. The first through fifth modular operators 411-415 may receive unsigned data D<6:0>. The first through fifth modular operators 411-415 are configured to perform first through fifth modular operations on the unsigned data D<6:0> using the first through fifth moduli m1-m5, respectively. The first through fifth modular operations may be performed in the same manner as the modular operations described with reference to FIG. 3.

Specifically, the first modular operator 411 is configured to perform a first modular operation on the unsigned data D<6:0> using the first modulus m1. The first modular operator 411 outputs a first redundant residue RRND1 as a result of the first modular operation. The second modular operator 412 is configured to perform a second modular operation on the unsigned data D<6:0> using the second modulus m2. The second modular operator 412 outputs a second redundant residue RRND2 as a result of the second modular operation. The third modular operator 413 is configured to perform a third modular operation on the unsigned data D<6:0> using the third modulus m3. The third modular operator 413 outputs a third redundant residue RRND3 as a result of the third modular operation. The fourth modular operator 414 is configured to perform a fourth modular operation on the unsigned data D<6:0> using the fourth modulus m4. The fourth modular operator 414 outputs a fourth redundant residue RRND4 as a result of the fourth modular operation. The fifth modular operator 415 is configured to perform a fifth modular operation on the unsigned data D<6:0> using the fifth modulus m5. The fifth modular operator 415 outputs a fifth redundant residue RRND5 as a result of the fifth modular operation.

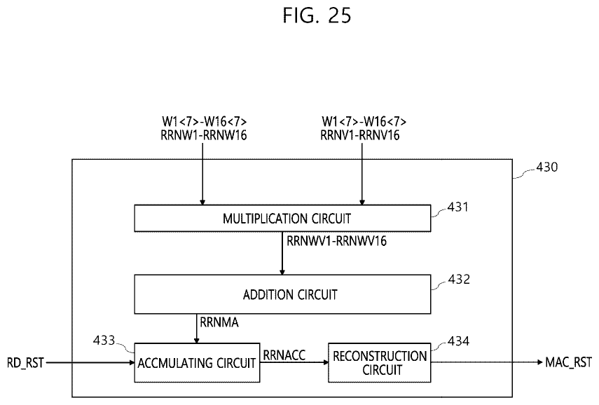

FIG. 25 is a block diagram illustrating a processing unit included in the PIM device of FIG. 22 according to an embodiment of the present disclosure. In the present example, the processing unit is assumed to have an operational capability of processing sixteen weight data and sixteen vector data in a single operation.

Referring to FIG. 25, the processing unit 430 includes a multiplication circuit 431, an addition circuit 432, an accumulation circuit 433, and a reconstruction circuit 434. The multiplication circuit 431 receives, from the memory circuit 420 of FIG. 22, first through sixteenth weight sign bits W1<7>-W16<7>, first through sixteenth weight redundant residue sets RRNW1-RRNW16, first through sixteenth vector sign bits V1<7>-V16<7>, and first through sixteenth vector redundant residue sets RRNV1-RRNV16. Each of the first through sixteenth weight redundant residue sets RRNW1-RRNW16 includes first through fifth weight redundant residues. Each of the first through sixteenth vector redundant residue sets RRNV1-RRNV16 includes first through fifth vector redundant residues.

The multiplication circuit 431 performs multiplication operations between the first through sixteenth weight redundant residue sets RRNW1-RRNW16 and the first through sixteenth vector redundant residue sets RRNV1-RRNV16, respectively, to generate and output first through sixteenth multiplication redundant residue sets RRNWV1-RRNWV16. Specifically, the multiplication circuit 431 performs a multiplication operation between the first weight redundant residue set RRNW1 and the first vector redundant residue set RRNV1 to generate and output a first multiplication redundant residue set RRNWV1. The multiplication circuit 431 performs a multiplication operation between the second weight redundant residue set RRNW2 and the second vector redundant residue set RRNV2 to generate and output a second multiplication redundant residue set RRNWV2. The multiplication circuit 431 generates and outputs third through sixteenth multiplication redundant residue sets RRNWV3-RRNWV16 in the same manner. Each of the first through sixteenth multiplication redundant residue sets RRNWV1-RRNWV16 includes first through fifth multiplication redundant residues. The multiplication circuit 431 may be configured in the same manner as the multiplication circuit 220 described with reference to FIGS. 7 through 13.

The addition circuit 432 receives first through sixteenth multiplication redundant residue sets RRNWV1-RRNWV16 output from the multiplication circuit 431. The addition circuit 432 performs addition operations on the first through sixteenth multiplication redundant residue sets RRNWV1-RRNWV16 to generate an addition redundant residue set RRNMA. Although not shown in the drawings, the addition redundant residue set RRNMA generated by the addition circuit 432 includes first through fifth addition redundant residues. The addition circuit 432 may be configured in the same manner as the addition circuit 230 described with reference to FIGS. 14 and 15.

The accumulation circuit 433 receives the addition redundant residue set RRNMA output from the addition circuit 432. The accumulation circuit 433 performs accumulation operations on the addition redundant residue set RRNMA and a latch redundant residue set to generate an accumulated redundant residue set RRNACC. Although not shown in the drawings, the accumulation circuit 433 performs first through fifth sub-accumulation operations that respectively accumulate the first through fifth addition redundant residues included in the addition redundant residue set RRNMA and the first through fifth latch redundant residues included in the latch redundant residue set. The accumulated redundant residue set RRNACC generated by the accumulation circuit 433 includes first through fifth accumulated redundant residues. The accumulation circuit 433 may be configured in the same manner as the accumulation circuit 240 described with reference to FIG. 16.

The reconstruction circuit 434 receives the accumulated redundant residue set RRNACC output from the accumulation circuit 433. The reconstruction circuit 434 generates multiply-accumulate (MAC) operation result data expressed in a binary weighted number system by using the first through fifth moduli m1-m5 and the first through fifth accumulated redundant residues included in the accumulated redundant residue set RRNACC. The reconstruction circuit 434 is configured to correct errors generated during the MAC operation process while generating the MAC operation result data. The reconstruction circuit 434 may be configured in the same manner as the reconstruction circuit 250 described with reference to FIGS. 17 through 21.

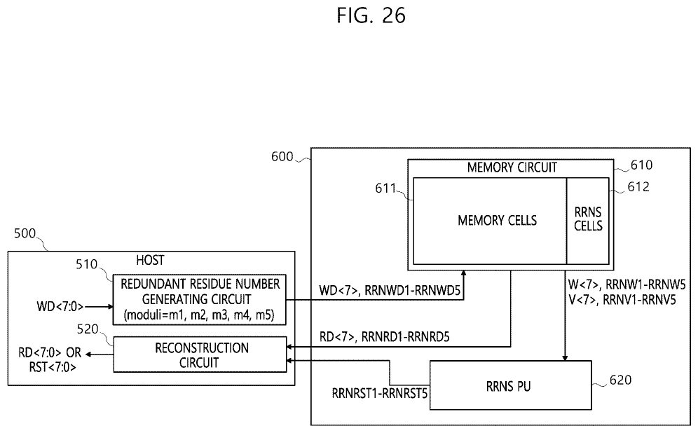

FIG. 26 is a block diagram illustrating an example of a PIM system according to an embodiment of the present disclosure.

Referring to FIG. 26, a PIM system includes a host 500 and a PIM device 600. The host 500 includes a redundant residue number generation circuit 510 and a reconstruction circuit 520. The PIM device 600 includes a memory circuit 610 having memory cells 611 and RRNS cells 612, and a processing unit 620 configured to perform an operation using RRNS-based data.

The redundant residue number generation circuit 510 included in the host 500 receives write data WD<7:0> to be written into the memory circuit 610 of the PIM device 600. The write data WD<7:0> has an 8-bit integer format in which the most significant bit represents a sign bit. The redundant residue number generation circuit 510 performs modular operations using first through fifth moduli on unsigned write data WD<6:0>, that is obtained by excluding the sign bit WD<7> from the write data WD<7:0>. As a result of the modular operations, the redundant residue number generation circuit 510 generates first through fifth redundant residues RRNWD1-RRNWD5 based on the RRNS. The redundant residue number generation circuit 510 transmits the sign bit WD<7> of the write data WD<7:0> and the first through fifth redundant residues RRNWD1-RRNWD5 to the PIM device 600. The redundant residue number generation circuit 510 may be configured in the same manner as the redundant residue number generation circuit 420 described with reference to FIG. 24. Accordingly, the configuration and operation of the redundant residue number generation circuit 210 described with reference to FIGS. 5 and 6 may also be applied to the redundant residue number generation circuit 420.

The reconstruction circuit 520 included in the host 500 may receive the sign bit RD<7> of read data and first through fifth redundant residues RRNRD1-RRNRD5 from the memory circuit 610 of the PIM device 600, or may receive first through fifth result redundant residues RRNRST1-RRNRST5 from the processing unit 620 of the PIM device 600.

When the sign bit RD<7> of the read data and the first through fifth redundant residues RRNRD1-RRNRD5 are transmitted from the memory circuit 610 of the PIM device 600, the reconstruction circuit 520 restores the sign bit RD<7> and the first through fifth redundant residues RRNRD1-RRNRD5 into read data RD<7:0> in a weighted number system, and outputs the restored data.

When the first through fifth result redundant residues RRNRST1-RRNRST5 are transmitted from the processing unit 620 of the PIM device 600, the reconstruction circuit 520 restores the first through fifth result redundant residues RRNRST1-RRNRST5 into result data RST<7:0> in a weighted number system, and outputs the result data.

The reconstruction circuit 520 may be configured in the same manner as the reconstruction circuit 250 described with reference to FIGS. 17 through 21. Accordingly, during the process of restoring data into the weighted number system, the reconstruction circuit 520 may perform error detection and error correction operations.

The redundant residue number generation circuit 510 and the reconstruction circuit 520 included in the host 500 may also be used for an encryption operation of the PIM system. For example, the redundant residue number generation circuit 510 may perform an operation of converting input data into a sign bit and first through fifth redundant residues as the encryption operation. In addition, the reconstruction circuit 520 may perform an operation of converting first through fifth redundant residues transmitted from the PIM device 600 into a real number in a weighted number system as the decryption operation. Such encryption and decryption operations, in an embodiment, may effectively defend against attacks such as hacking, because unless the values of the first through fifth moduli used in the redundant residue generation process are known, the encrypted data cannot be restored.

The memory circuit 610 may store a sign bit WD<7> of the write data WD<7:0> and first through fifth redundant residues RRNWD1-RRNWD5, that are transmitted from the redundant residue number generation circuit 510 of the host 500, through a data write operation. The manner in which the sign bit WD<7> and the first through fifth redundant residues RRNWD1-RRNWD5 are stored in the memory circuit 610 may be performed in the same manner as the storage of the sign bit D<7> and the first through fifth redundant residues RRND1-RRND5 in the memory circuit 420, as described with reference to FIG. 23.

The memory circuit 610 may transmit a sign bit RD<7> and first through fifth redundant residues RRNRD1-RRNRD5, that are stored in the memory circuit 610, to the reconstruction circuit 520 of the host 500 through a data read operation. In addition, the memory circuit 610 may provide a sign bit of weight data, i.e., a weight sign bit W<7>, and first through fifth weight redundant residues RRNW1-RRNW5, as well as a sign bit of vector data, i.e., a vector sign bit V<7>, and first through fifth vector redundant residues RRNV1-RRNV5, to the processing unit 620.

The processing unit 620 may perform an operation, such as a MAC operation, on the weight sign bit W<7> and the first through fifth weight redundant residues RRNW1-RRNW5, together with the vector sign bit V<7> and the first through fifth vector redundant residues RRNV1-RRNV5, provided from the memory circuit 610. The processing unit 620 may transmit first through fifth accumulated redundant residues, that are generated as results of the MAC operation, as MAC result redundant residues RRNRST1-RRNRST5 to the reconstruction circuit 520 of the host 500. The processing unit 620 may be configured in the same manner as the processing unit 430 described with reference to FIG. 25, except that the reconstruction circuit is omitted.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A processing unit comprising:
a redundant residue number generation circuit configured to convert first operand data and second operand data into a plurality of first operand redundant residue number sets and a plurality of second operand redundant residue number sets based on a redundant residue number system (RRNS) using first to T-th moduli, wherein T is a natural number equal to or greater than four;
a plurality of arithmetic circuits configured to perform operations using the plurality of first operand redundant residue number sets and the plurality of second operand redundant residue number sets; and
a reconstruction circuit configured to recover result data based on the RRNS into result data based on a weighted number system.

2. The processing unit of claim 1,
wherein the first to T-th moduli satisfy a condition of being pairwise relatively prime, and
wherein a product of the first to third moduli among the first to T-th moduli is set to be greater than a maximum value among possible values of each of first to M-th weight data and first to M-th vector data.

3. The processing unit of claim 1,
wherein the first operand data includes first to M-th weight data, wherein M is a natural number equal to or greater than two,
wherein the second operand data includes first to M-th vector data,
wherein each of the first to M-th weight data has a signed integer data format including a most significant bit (MSB) as a sign bit and unsigned weight data, and
wherein each of the first to M-th vector data has the signed integer data format including the MSB as the sign bit and unsigned vector data.

4. The processing unit of claim 3,
wherein the redundant residue number generation circuit is configured to convert first to M-th unsigned weight data and first to M-th unsigned vector data into first to M-th weight redundant residue number sets and first to M-th vector redundant residue number sets based on the RRNS using the first to T-th moduli.

5. The processing unit of claim 4,
wherein the redundant residue number generation circuit is configured to receive first to M-th sign bits of the first to M-th weight data and first to M-th sign bits of the first to M-th vector data, and to output the received sign bits in the same form as received without modification.

6. The processing unit of claim 5,
wherein the redundant residue number generation circuit includes first to M-th modular arithmetic circuits,
wherein a K-th modular arithmetic circuit among the first to M-th modular arithmetic circuits includes first to T-th sub-modular operators,
wherein an F-th sub-modular operator among the first to T-th sub-modular operators is configured to perform an F-th sub-modular operation using an F-th modulus on a K-th unsigned weight data and a K-th unsigned vector data, to generate an F-th weight redundant residue of a K-th weight redundant residue number set and an F-th vector redundant residue of a K-th vector redundant residue number set,
wherein K is a natural number from 1 to M, and
wherein F is a natural number from 1 to T.

7. The processing unit of claim 4, wherein the arithmetic circuits include:
a multiplication circuit configured to perform multiplication operations on the first to M-th weight redundant residue number sets and the first to M-th vector redundant residue number sets to generate first to M-th multiplication redundant residue number sets;
an addition circuit configured to perform an addition operation on the first to M-th multiplication redundant residue number sets to generate an addition redundant residue number set; and
an accumulation circuit configured to perform an accumulation operation on the addition redundant residue number set and a latch redundant residue number set to generate an accumulated redundant residue number set,
wherein each of the first to M-th multiplication redundant residue number sets includes first to T-th multiplication redundant residues,
wherein the addition redundant residue number set includes first to T-th addition redundant residues, and
wherein the accumulated redundant residue number set includes first to T-th accumulated redundant residues.

8. The processing unit of claim 7,
wherein the multiplication circuit includes first to M-th sub-multiplication circuits,
wherein a K-th sub-multiplication circuit among the first to M-th sub-multiplication circuits is configured to receive a sign bit of a K-th weight data, a sign bit of a K-th vector data, first to T-th redundant residues of a K-th weight redundant residue number set, and first to T-th redundant residues of a K-th vector redundant residue number set, and to generate and output first to T-th multiplication redundant residues of a K-th multiplication redundant residue number set, and
wherein K is a natural number from 1 to M.

9. The processing unit of claim 8,
wherein the K-th sub-multiplication circuit includes an exclusive OR (XOR) operator, first to T-th multipliers, and a sign bit appending unit,
wherein the XOR operator is configured to perform an exclusive OR operation on a sign bit of the K-th weight data and a sign bit of the K-th vector data to generate a K-th multiplication sign bit,
wherein an F-th multiplier among the first to T-th multipliers is configured to perform an F-th sub-multiplication operation on an F-th weight redundant residue of the K-th weight redundant residue number set and an F-th vector redundant residue of the K-th vector redundant residue number set to generate an F-th multiplication redundant residue of the K-th multiplication redundant residue number set, and
wherein the sign bit appending unit is configured to append the K-th multiplication sign bit to most significant bits of the first to T-th multiplication redundant residues of the K-th multiplication redundant residue number set and to output the result.

10. The processing unit of claim 9, wherein each of the first to T-th multipliers includes:
an AND array block including a plurality of NAND gate-inverter pairs arranged in an array form; and
an adder configured to perform an addition operation on partial product data output from the AND array block.

11. The processing unit of claim 7, wherein the accumulation circuit includes:
first to T-th accumulation adders configured to perform accumulation operations on first to T-th addition redundant residues of the addition redundant residue number set and first to T-th latch redundant residues to output first to T-th accumulated redundant residues of the accumulated redundant residue number set;
first to T-th latch circuits configured to latch the first to T-th accumulated redundant residues output from the first to T-th accumulation adders and to provide them as first to T-th latch redundant residues for a subsequent operation; and
first to T-th output buffers configured to receive the first to T-th accumulated redundant residues latched in the first to T-th latch circuits and to switch output operations of the first to T-th accumulated redundant residues in response to a control signal.

12. The processing unit of claim 7, wherein the reconstruction circuit includes:
a real number generation circuit configured to receive the first to T-th moduli and the first to T-th accumulated redundant residues of the accumulated redundant residue number set, and to generate and output first to tenth real numbers; and
an error-corrected real number generation circuit configured to perform an error detection and correction operation on the first to T-th accumulated redundant residues of the accumulated redundant residue number set based on the first to tenth real numbers, and to reconstruct the first to T-th accumulated redundant residues into MAC result data based on a weighted number system.

13. The processing unit of claim 12, wherein the real number generation circuit includes:
a combination generation circuit configured to generate and output first to L-th combination sets based on the first to T-th accumulated redundant residues and the first to T-th moduli; and
first to L-th real number calculators configured to generate and output first to L-th real numbers using the first to L-th combination sets,
wherein L is a result value of a combinatorial calculation of selecting three out of T.

14. The processing unit of claim 13,
wherein the combination generation circuit is configured to generate the first to L-th combination sets such that each of the first to L-th combination sets includes three accumulated redundant residues selected without duplication from among the first to T-th accumulated redundant residues, and three moduli corresponding to the selected three accumulated redundant residues.

15. The processing unit of claim 13, wherein the error-corrected real number generation circuit includes:
a real number filter circuit configured to perform filtering on the first to L-th real numbers and to output selected real numbers based on the filtering;
a redundant residue number compare circuit configured to perform a first comparison operation on the selected real numbers output from the real number filter circuit and a second comparison operation on the accumulated redundant residues used to generate the selected real numbers, and to output comparison result data, wherein the comparison result data includes information about a common value of the majority of the real numbers and an accumulated redundant residue that is not used to generate the real numbers having the common value;
a correction circuit configured to calculate and output an error-corrected accumulated redundant residue using the common value of the majority of the real numbers and the accumulated redundant residue that is not used to generate the real numbers having the common value; and
a real number determination circuit configured to recalculate a real number based on the error-corrected accumulated redundant residue output from the correction circuit, and to generate and output error-corrected MAC result data.

16. The processing unit of claim 15,
wherein the real number filter circuit is configured to perform the filtering by selecting real numbers having values less than or equal to a product of the first, second, and third moduli, that are information moduli.

17. The processing unit of claim 15, wherein the redundant residue number compare circuit is configured to:
perform the first comparison operation by comparing the selected real numbers output from the real number filter circuit to detect the common value of the majority of the real numbers; and
perform the second comparison operation by comparing accumulated redundant residues used to generate a real number having a different value with accumulated redundant residues used to generate real numbers having the common value, to detect an erroneous accumulated redundant residue that is not used in generating the real numbers having the common value but is used only in generating the real number having the different value.

18. The processing unit of claim 15,
wherein the correction circuit is configured to perform a modular operation that calculates a remainder obtained by dividing the common value of the majority of the real numbers by a modulus corresponding to the erroneous accumulated redundant residue, to compute the error-corrected redundant residue.

19. The processing unit of claim 15,
wherein the real number determination circuit is configured to recalculate the real number based on the accumulated redundant residues and corresponding moduli used to generate the selected real numbers, and to generate and output the error-corrected MAC result data.

20. A processing-in-memory (PIM) device comprising:
a memory circuit configured to provide first to M-th weight data and first to M-th vector data; and
a processing unit configured to convert the first to M-th weight data and the first to M-th vector data into first to M-th weight redundant residue number sets and first to M-th vector redundant residue number sets based on a redundant residue number system (RRNS) using first to T-th moduli, wherein T is a natural number equal to or greater than four, and to perform multiplication and accumulation (MAC) operations,
wherein the processing unit is configured to perform a reconstruction operation to recover RRNS-based MAC result data generated as a result of the MAC operations into MAC result data based on a weighted number system, and to correct errors that occur in the RRNS-based MAC result data during the MAC operations, and
wherein M is a natural number equal to or greater than two.

21. The PIM device of claim 20, further comprising an error correction code (ECC) circuit,
wherein the ECC circuit includes:
an ECC encoder configured to perform ECC encoding on write data transmitted from a host to generate parity data and to transmit the write data and the parity data to the memory circuit; and
an ECC decoder configured to perform ECC decoding using the parity data on read data transmitted from the memory circuit, and to perform error detection and error correction on the read data.

22. The PIM device of claim 21, wherein the memory circuit includes:
memory cells configured to store the write data; and
ECC cells configured to store the parity data.

23. The PIM device of claim 21,
wherein the ECC decoder is configured to transmit the read data, on which the ECC decoding has been performed, to the host or the processing unit.

24. The PIM device of claim 20,
wherein the first to T-th moduli satisfy a condition of being pairwise relatively prime, and
wherein a product of the first to third moduli among the first to T-th moduli is set to be greater than a maximum value among possible values of each of the first to M-th weight data and each of the first to M-th vector data.

25. The PIM device of claim 20,
wherein each of the first to M-th weight data has a signed integer data format including a most significant bit (MSB) as a sign bit and unsigned weight data, and
wherein each of the first to M-th vector data has the signed integer data format including the MSB as the sign bit and unsigned vector data.

26. The PIM device of claim 25, wherein the processing unit includes:
a redundant residue number generation circuit configured to convert first to M-th unsigned weight data into first to M-th weight redundant residue number sets based on the RRNS using the first to T-th moduli, and to convert first to M-th unsigned vector data into first to M-th vector redundant residue number sets based on the RRNS using the first to T-th moduli;
a multiplication circuit configured to perform multiplication operations on the first to M-th weight redundant residue number sets and the first to M-th vector redundant residue number sets to generate first to M-th multiplication redundant residue number sets;
an addition circuit configured to perform an addition operation on the first to M-th multiplication redundant residue number sets to generate an addition redundant residue number set;
an accumulation circuit configured to perform an accumulation operation on the addition redundant residue number set and a latch redundant residue number set to generate an accumulated redundant residue number set; and
a reconstruction circuit configured to reconstruct the accumulated redundant residue number set into MAC result data based on a weighted number system and to correct an error included in the accumulated redundant residue number set.

27. The PIM device of claim 26,
wherein the redundant residue number generation circuit is configured to receive first to M-th sign bits of the first to M-th weight data and first to M-th sign bits of the first to M-th vector data, and to output the received sign bits in the same form as received without modification.

28. The PIM device of claim 26,
wherein each of the first to M-th weight redundant residue number sets includes first to T-th weight redundant residues,
wherein each of the first to M-th vector redundant residue number sets includes first to T-th vector redundant residues,
wherein each of the first to M-th multiplication redundant residue number sets includes first to T-th multiplication redundant residues,
wherein the addition redundant residue number set includes first to T-th addition redundant residues, and
wherein the accumulated redundant residue number set includes first to T-th accumulated redundant residues.

29. The PIM device of claim 28,
wherein the redundant residue number generation circuit includes first to M-th modular arithmetic circuits,
wherein a K-th modular arithmetic circuit among the first to M-th modular arithmetic circuits includes first to T-th sub-modular operators, and
wherein an F-th sub-modular operator among the first to T-th sub-modular operators is configured to perform an F-th sub-modular operation using an F-th modulus on a K-th unsigned weight data and a K-th unsigned vector data, and to generate an F-th weight redundant residue of a K-th weight redundant residue number set and an F-th vector redundant residue of a K-th vector redundant residue number set,
wherein K is a natural number from 1 to M, and
wherein F is a natural number from 1 to T.

30. The PIM device of claim 28,
wherein the multiplication circuit includes first to M-th sub-multiplication circuits,
wherein a K-th sub-multiplication circuit among the first to M-th sub-multiplication circuits is configured to receive a sign bit of a K-th weight data, a sign bit of a K-th vector data, first to T-th redundant residues of a K-th weight redundant residue number set, and first to T-th redundant residues of a K-th vector redundant residue number set, and to generate and output first to T-th multiplication redundant residues of a K-th multiplication redundant residue number set, and
wherein K is a natural number from 1 to M.

31. The PIM device of claim 30,
wherein the K-th sub-multiplication circuit includes an exclusive OR (XOR) operator, first to T-th multipliers, and a sign bit appending unit,
wherein the XOR operator is configured to perform an exclusive OR operation on a sign bit of the K-th weight data and a sign bit of the K-th vector data to generate a K-th multiplication sign bit,
wherein an F-th multiplier among the first to T-th multipliers is configured to perform an F-th sub-multiplication operation on an F-th weight redundant residue of the K-th weight redundant residue number set and an F-th vector redundant residue of the K-th vector redundant residue number set to generate an F-th multiplication redundant residue of the K-th multiplication redundant residue number set, and
wherein the sign bit appending unit is configured to append the K-th multiplication sign bit to most significant bits of the first to T-th multiplication redundant residues of the K-th multiplication redundant residue number set.

32. The PIM device of claim 31, wherein each of the first to T-th multipliers includes:
an AND array block including a plurality of NAND gate-inverter pairs arranged in an array form; and
an adder configured to perform an addition operation on partial product data output from the AND array block.

33. The PIM device of claim 28, wherein the accumulation circuit includes:
first to T-th accumulation adders configured to perform accumulation operations on first to T-th addition redundant residues of the addition redundant residue number set and first to T-th latch redundant residues, and to output first to T-th accumulated redundant residues of the accumulated redundant residue number set;
first to T-th latch circuits configured to latch the first to T-th accumulated redundant residues output from the first to T-th accumulation adders, and to provide the first to T-th accumulated redundant residues as first to T-th latch redundant residues for a subsequent operation; and
first to T-th output buffers configured to receive the first to T-th accumulated redundant residues latched in the first to T-th latch circuits, and to switch output operations of the first to T-th accumulated redundant residues in response to a control signal.

34. The PIM device of claim 28, wherein the reconstruction circuit includes:
a real number generation circuit configured to receive the first to T-th moduli and the first to T-th accumulated redundant residues of the accumulated redundant residue number set, and to generate and output first to L-th real numbers; and
an error-corrected real number generation circuit configured to perform an error detection and correction operation on the first to T-th accumulated redundant residues of the accumulated redundant residue number set based on the first to L-th real numbers, and to reconstruct the first to T-th accumulated redundant residues into MAC result data based on a weighted number system,
wherein L is a result value of a combinatorial calculation of selecting three out of T.

35. The PIM device of claim 34, wherein the real number generation circuit includes:
a combination generation circuit configured to generate and output first to L-th combination sets based on the first to T-th accumulated redundant residues and the first to T-th moduli; and
first to L-th real number calculators configured to generate and output first to L-th real numbers using the first to L-th combination sets.

36. The PIM device of claim 35,
wherein the combination generation circuit is configured to generate the first to L-th combination sets such that each of the first to L-th combination sets includes three accumulated redundant residues selected without duplication from among the first to T-th accumulated redundant residues, and three moduli corresponding to the selected three accumulated redundant residues.

37. The PIM device of claim 35, wherein the error-corrected real number generation circuit includes:
a real number filter circuit configured to perform filtering on the first to L-th real numbers and to output selected real numbers based on the filtering;
a redundant residue number compare circuit configured to perform a first comparison operation on the selected real numbers output from the real number filter circuit and a second comparison operation on accumulated redundant residues used to generate the selected real numbers, and to output comparison result data, wherein the comparison result data includes information about a common value of the majority of the real numbers and an accumulated redundant residue that is not used to generate the real numbers having the common value;
a correction circuit configured to calculate and output an error-corrected accumulated redundant residue using the common value of the majority of the real numbers and the accumulated redundant residue that is not used to generate the real numbers having the common value; and
a real number determination circuit configured to recalculate a real number based on the error-corrected accumulated redundant residue output from the correction circuit, and to generate and output error-corrected MAC result data.

38. The PIM device of claim 37,
wherein the real number filter circuit is configured to perform the filtering by selecting real numbers having values less than or equal to a product of first, second, and third moduli, that are information moduli.

39. The PIM device of claim 37, wherein the redundant residue number compare circuit is configured to:
perform the first comparison operation by comparing the selected real numbers output from the real number filter circuit to detect the common value of the majority of the real numbers; and
perform the second comparison operation by comparing accumulated redundant residues used to generate a real number having a different value with accumulated redundant residues used to generate real numbers having the common value, to detect an erroneous accumulated redundant residue that is not used in generating the real numbers having the common value but is used only in generating the real number having the different value.

40. The PIM device of claim 37,
wherein the correction circuit is configured to perform a modular operation that calculates a remainder obtained by dividing the common value of the majority of the real numbers by a modulus corresponding to the erroneous accumulated redundant residue, to compute the error-corrected redundant residue.

41. The PIM device of claim 37,
wherein the real number determination circuit is configured to recalculate the real number based on the accumulated redundant residues and corresponding moduli used to generate the selected real numbers, and to generate and output error-corrected MAC result data.

42. A processing-in-memory (PIM) device comprising:
a redundant residue number generation circuit configured to receive data in an 8-bit integer format from a host, perform modular operations on unsigned data excluding a sign bit using first to T-th moduli to generate first to T-th redundant residues based on a redundant residue number system (RRNS), and to output the redundant residues together with the sign bit;
a memory circuit configured to receive and store the sign bit and the first to T-th redundant residues output from the redundant residue number generation circuit; and
a processing unit configured to receive the sign bit and the first to T-th redundant residues from the memory circuit as operands and to perform multiplication and accumulation (MAC) operations,
wherein T is a natural number equal to or greater than four.

43. The PIM device of claim 42, wherein the memory circuit includes:
memory cells configured to store the sign bit and a first portion of the first to T-th redundant residues; and
redundant residue system cells configured to store a second portion of the first to T-th redundant residues.

44. The PIM device of claim 42,
wherein the redundant residue number generation circuit includes first to T-th modular operators,
wherein an F-th modular operator among the first to T-th modular operators is configured to perform an F-th modular operation using an F-th modulus on the unsigned data to generate an F-th redundant residue,
wherein F is a natural number from 1 to T.

45. The PIM device of claim 42,
wherein the processing unit is configured to:
receive, from the memory circuit, first to M-th weight sign bits, first to M-th vector sign bits, first to M-th weight redundant residue number sets, and first to M-th vector redundant residue number sets;
perform the MAC operation using the first to M-th weight sign bits, the first to M-th vector sign bits, the first to M-th weight redundant residue number sets, and the first to M-th vector redundant residue number sets to generate first to T-th accumulated redundant residues based on the RRNS; and
perform a reconstruction operation to recover the accumulated redundant residues into MAC result data based on a weighted number system, while correcting errors included in the accumulated redundant residues,
wherein each of the first to M-th weight redundant residue number sets includes first to T-th weight redundant residues,
wherein each of the first to M-th vector redundant residue number sets includes first to T-th vector redundant residues, and
wherein M is a natural number equal to or greater than two.

46. The PIM device of claim 45, wherein the processing unit includes:
a multiplication circuit configured to perform multiplication operations on the first to M-th weight redundant residue number sets and the first to M-th vector redundant residue number sets to generate first to M-th multiplication redundant residue number sets, each of which includes first to T-th multiplication redundant residues;
an addition circuit configured to perform an addition operation on the first to M-th multiplication redundant residue number sets to generate an addition redundant residue number set including first to T-th addition redundant residues;
an accumulation circuit configured to perform accumulation operations on the first to T-th addition redundant residues and first to T-th latch redundant residues to generate first to T-th accumulated redundant residues; and
a reconstruction circuit configured to reconstruct the first to T-th accumulated redundant residues into MAC result data based on a weighted number system, while correcting errors included in the first to T-th accumulated redundant residues.

47. The PIM device of claim 46,
wherein the multiplication circuit includes first to M-th sub-multiplication circuits,
wherein a K-th sub-multiplication circuit among the first to M-th sub-multiplication circuits is configured to receive a K-th weight sign bit, a K-th vector sign bit, first to T-th redundant residues of a K-th weight redundant residue number set, and first to T-th redundant residues of a K-th vector redundant residue number set, and to generate and output first to T-th multiplication redundant residues of a K-th multiplication redundant residue number set, and
wherein K is a natural number from 1 to M.

48. The PIM device of claim 47,
wherein the K-th sub-multiplication circuit includes an exclusive OR (XOR) operator, first to T-th multipliers, and a sign bit appending unit,
wherein the XOR operator is configured to perform an exclusive OR operation on the K-th weight sign bit and the K-th vector sign bit to generate a K-th multiplication sign bit,
wherein an F-th multiplier among the first to T-th multipliers is configured to perform an F-th sub-multiplication operation on an F-th weight redundant residue of the K-th weight redundant residue number set and an F-th vector redundant residue of the K-th vector redundant residue number set to generate an F-th multiplication redundant residue of the K-th multiplication redundant residue number set, and
wherein the sign bit appending unit is configured to append the K-th multiplication sign bit to most significant bits of the first to T-th multiplication redundant residues of the K-th multiplication redundant residue number set.

49. The PIM device of claim 48, wherein each of the first to T-th multipliers includes:
an AND array block including a plurality of NAND gate-inverter pairs arranged in an array form; and
an adder configured to perform an addition operation on partial product data output from the AND array block.

50. The PIM device of claim 46, wherein the accumulation circuit includes:
first to T-th accumulation adders configured to perform accumulation operations on the first to T-th addition redundant residues and the first to T-th latch redundant residues to output first to T-th accumulated redundant residues;
first to T-th latch circuits configured to latch the first to T-th accumulated redundant residues output from the first to T-th accumulation adders and to provide the first to T-th accumulated redundant residues as first to T-th latch redundant residues for a subsequent operation; and
first to T-th output buffers configured to receive the first to T-th accumulated redundant residues latched in the first to T-th latch circuits and to switch output operations of the first to T-th accumulated redundant residues in response to a control signal.

51. The PIM device of claim 46, wherein the reconstruction circuit includes:
a real number generation circuit configured to receive the first to T-th moduli and the first to T-th accumulated redundant residues, and to generate and output first to L-th real numbers; and
an error-corrected real number generation circuit configured to perform an error detection and correction operation on the first to T-th accumulated redundant residues of the accumulated redundant residue number set based on the first to L-th real numbers, and to reconstruct the first to T-th accumulated redundant residues into MAC result data based on a weighted number system,
wherein L is a result value of a combinatorial calculation of selecting three out of T.

52. The PIM device of claim 51, wherein the real number generation circuit includes:
a combination generation circuit configured to generate and output first to L-th combination sets based on the first to T-th accumulated redundant residues and the first to T-th moduli; and
first to L-th real number calculators configured to generate and output the first to L-th real numbers using the first to L-th combination sets.

53. The PIM device of claim 52,
wherein the combination generation circuit is configured to generate the first to L-th combination sets such that each of the first to L-th combination sets includes three accumulated redundant residues selected without duplication from among the first to T-th accumulated redundant residues, and three moduli corresponding to the selected three accumulated redundant residues.

54. The PIM device of claim 52, wherein the error-corrected real number generation circuit includes:
a real number filter circuit configured to perform filtering on the first to L-th real numbers and to output selected real numbers based on the filtering;
a redundant residue number compare circuit configured to perform a first comparison operation on the selected real numbers output from the real number filter circuit and a second comparison operation on accumulated redundant residues used to generate the selected real numbers, and to output comparison result data, wherein the comparison result data includes information about a common value of the majority of the real numbers and an accumulated redundant residue that is not used to generate the real numbers having the common value;
a correction circuit configured to calculate and output an error-corrected accumulated redundant residue using the common value of the majority of the real numbers and the accumulated redundant residue that is not used to generate the real numbers having the common value; and
a real number determination circuit configured to recalculate a real number based on the error-corrected accumulated redundant residue output from the correction circuit, and to generate and output error-corrected MAC result data.

55. The PIM device of claim 54,
wherein the real number filter circuit is configured to perform the filtering by selecting real numbers having values less than or equal to a product of first, second, and third moduli, that are information moduli.

56. The PIM device of claim 54, wherein the redundant residue number compare circuit is configured to:
perform the first comparison operation by comparing the selected real numbers output from the real number filter circuit to detect the common value of the majority of the real numbers; and
perform the second comparison operation by comparing accumulated redundant residues used to generate a real number having a different value with accumulated redundant residues used to generate real numbers having the common value, to detect an erroneous accumulated redundant residue that is not used in generating the real numbers having the common value but is used only in generating the real number having the different value.

57. The PIM device of claim 54,
wherein the correction circuit is configured to perform a modular operation that calculates a remainder obtained by dividing common value of the majority of the real numbers by a modulus corresponding to the erroneous accumulated redundant residue, to compute the error-corrected accumulated redundant residue.

58. The PIM device of claim 54,
wherein the real number determination circuit is configured to recalculate the real number based on the accumulated redundant residues and corresponding moduli used to generate the selected real numbers, and to generate and output error-corrected MAC result data.

59. A processing-in-memory (PIM) system comprising:
a host including a redundant residue number generation circuit configured to perform modular operations on unsigned write data, that excludes a sign bit of write data in an 8-bit signed integer format, using first to T-th moduli, wherein T is a natural number equal to or greater than four, to generate first to T-th redundant residues based on a redundant residue number system (RRNS), and to output the redundant residues together with the sign bit; and
a PIM device including a memory circuit configured to receive and store the sign bit and the first to T-th redundant residues output from the host, and a processing unit configured to receive the sign bit and the first to T-th redundant residues from the memory circuit as operands and to perform multiplication and accumulation (MAC) operations.

60. The PIM system of claim 59, wherein the memory circuit includes:
memory cells configured to store the sign bit and a first portion of the first to T-th redundant residues; and
redundant residue system cells configured to store a second portion of the first to T-th redundant residues.

61. The PIM system of claim 59,
wherein the redundant residue number generation circuit includes first to T-th modular operators,
wherein an F-th modular operator among the first to T-th modular operators is configured to perform an F-th modular operation using an F-th modulus on the unsigned write data to generate an F-th redundant residue wherein F is a natural number from 1 to T.

62. The PIM system of claim 59, wherein the processing unit is configured to:
receive, from the memory circuit, first to M-th weight sign bits, first to M-th vector sign bits, first to M-th weight redundant residue number sets, and first to M-th vector redundant residue number sets; and
perform the MAC operation using the first to M-th weight sign bits, the first to M-th vector sign bits, the first to M-th weight redundant residue number sets, and the first to M-th vector redundant residue number sets to generate first to T-th accumulated redundant residues based on the RRNS,
wherein each of the first to M-th weight redundant residue number sets includes first to T-th weight redundant residues,
wherein each of the first to M-th vector redundant residue number sets includes first to T-th vector redundant residues, and
wherein M is a natural number equal to or greater than two.

63. The PIM system of claim 62, wherein the processing unit includes:
a multiplication circuit configured to perform multiplication operations on the first to M-th weight redundant residue number sets and the first to M-th vector redundant residue number sets to generate first to M-th multiplication redundant residue number sets, each of which includes first to T-th multiplication redundant residues;
an addition circuit configured to perform an addition operation on the first to M-th multiplication redundant residue number sets to generate an addition redundant residue number set including first to T-th addition redundant residues; and
an accumulation circuit configured to perform accumulation operations on the first to T-th addition redundant residues and first to T-th latch redundant residues to generate first to T-th accumulated redundant residues.

64. The PIM system of claim 63,
wherein the multiplication circuit includes first to M-th sub-multiplication circuits,
wherein a K-th sub-multiplication circuit among the first to M-th sub-multiplication circuits is configured to receive a K-th weight sign bit, a K-th vector sign bit, first to T-th redundant residues of a K-th weight redundant residue number set, and first to T-th redundant residues of a K-th vector redundant residue number set, and to generate and output first to T-th multiplication redundant residues of a K-th multiplication redundant residue number set,
wherein K is a natural number from 1 to M.

65. The PIM system of claim 64,
wherein the K-th sub-multiplication circuit includes an exclusive OR (XOR) operator, first to T-th multipliers, and a sign bit appending unit,
wherein the XOR operator is configured to perform an exclusive OR operation on the K-th weight sign bit and the K-th vector sign bit to generate a K-th multiplication sign bit,
wherein an F-th multiplier among the first to T-th multipliers is configured to perform an F-th sub-multiplication operation on an F-th weight redundant residue of the K-th weight redundant residue number set and an F-th vector redundant residue of the K-th vector redundant residue number set to generate an F-th multiplication redundant residue of the K-th multiplication redundant residue number set, and
wherein the sign bit appending unit is configured to append the K-th multiplication sign bit to most significant bits of the first to T-th multiplication redundant residues of the K-th multiplication redundant residue number set.

66. The PIM system of claim 65, wherein each of the first to T-th multipliers includes:
an AND array block including a plurality of NAND gate-inverter pairs arranged in an array form; and
an adder configured to perform an addition operation on partial product data output from the AND array block.

67. The PIM system of claim 63, wherein the accumulation circuit includes:
first to T-th accumulation adders configured to perform accumulation operations on the first to T-th addition redundant residues and the first to T-th latch redundant residues to output first to T-th accumulated redundant residues;
first to T-th latch circuits configured to latch the first to T-th accumulated redundant residues output from the first to T-th accumulation adders and to provide the first to T-th accumulated redundant residues as first to T-th latch redundant residues for a subsequent operation; and
first to T-th output buffers configured to receive the first to T-th accumulated redundant residues latched in the first to T-th latch circuits and to switch output operations of the first to T-th accumulated redundant residues in response to a control signal.

68. The PIM system of claim 62,
wherein the host further includes a reconstruction circuit configured to receive the first to T-th accumulated redundant residues from the processing unit, and to reconstruct the first to T-th accumulated redundant residues into MAC result data based on a weighted number system, while correcting errors included in the first to T-th accumulated redundant residues.

69. The PIM system of claim 68, wherein the reconstruction circuit includes:
a real number generation circuit configured to receive the first to T-th moduli and the first to T-th accumulated redundant residues, and to generate and output first to L-th real numbers; and
an error-corrected real number generation circuit configured to reconstruct the first to T-th accumulated redundant residues into MAC result data based on a weighted number system based on the first to L-th real numbers, and to perform error detection and correction operations on the first to T-th accumulated redundant residues,
wherein L is a result value of a combinatorial calculation of selecting three out of T.

70. The PIM system of claim 69, wherein the real number generation circuit includes:
a combination generation circuit configured to generate and output first to L-th combination sets based on the first to T-th accumulated redundant residues and the first to T-th moduli; and
first to L-th real number calculators configured to generate and output the first to L-th real numbers using the first to L-th combination sets.

71. The PIM system of claim 70,
wherein the combination generation circuit is configured to generate the first to L-th combination sets such that each of the first to L-th combination sets includes three accumulated redundant residues selected without duplication from among the first to T-th accumulated redundant residues, and three moduli corresponding to the selected three accumulated redundant residues.

72. The PIM system of claim 70, wherein the error-corrected real number generation circuit includes:
a real number filter circuit configured to perform filtering on the first to L-th real numbers and to output selected real numbers based on the filtering;
a redundant residue number compare circuit configured to perform a first comparison operation on the selected real numbers output from the real number filter circuit and a second comparison operation on accumulated redundant residues used to generate the selected real numbers, and to output comparison result data, wherein the comparison result data includes information about a common value of the majority of the real numbers and an accumulated redundant residue that is not used to generate the real numbers having the common value;
a correction circuit configured to calculate and output an error-corrected accumulated redundant residue using the common value of the majority of the real numbers and the accumulated redundant residue that is not used to generate the real numbers having the common value; and
a real number determination circuit configured to recalculate a real number based on the error-corrected accumulated redundant residue output from the correction circuit, and to generate and output error-corrected MAC result data.

73. The PIM system of claim 72,
wherein the real number filter circuit is configured to perform the filtering by selecting real numbers having values less than or equal to a product of first, second, and third moduli, that are information moduli.

74. The PIM system of claim 72, wherein the redundant residue number compare circuit is configured to:
perform the first comparison operation by comparing the selected real numbers output from the real number filter circuit to detect the common value of the majority of the real numbers; and
perform the second comparison operation by comparing accumulated redundant residues used to generate a real number having a different value with accumulated redundant residues used to generate real numbers having the common value, to detect an erroneous accumulated redundant residue that is not used in generating the real numbers having the common value but is used only in generating the real number having the different value.

75. The PIM system of claim 72,
wherein the correction circuit is configured to perform a modular operation that calculates a remainder obtained by dividing the common value of the majority of the real numbers by a modulus corresponding to the erroneous accumulated redundant residue, to compute the error-corrected accumulated redundant residue.

76. The PIM system of claim 72,
wherein the real number determination circuit is configured to recalculate the real number based on the accumulated redundant residues and corresponding moduli used to generate the selected real numbers, and to generate and output error-corrected MAC result data.
